(19) United States
(12) Patent Application Publication
(10) Pub. No.: US 2026/0129429 A1
(43) Pub. Date: May 7, 2026

(54) MODEL TUNING FOR CROSS NODE MACHINE LEARNING

(71) Applicant: QUALCOMM Incorporated, San Diego, CA (US)

(72) Inventors: Bongyong SONG, San Diego, CA (US); Taesang YOO, San Diego, CA (US); Chenxi HAO, Beijing (CN); Jay Kumar SUNDARARAJAN, San Diego, CA (US); June NAMGOONG, San Diego, CA (US)

(21) Appl. No.: 19/114,360

(22) PCT Filed: Nov. 22, 2022
(86) PCT No.: PCT/CN2022/133369

§ 371 Date: Mar. 21, 2025

(51) Int. Cl. H04W 8/24; G06N 20/00; H04B 7/06

(52) U.S. Cl. CPC H04W 8/24; G06N 20/00; H04B 7/0626

(57) ABSTRACT

Methods, systems, and devices for wireless communications are described. A user equipment (UE) may obtain data samples for a first machine learning model associated with a task at the UE. The first set of parameters may be associated with the first machine learning model. The UE may transmit a capability message indicating a capability of the UE to perform a tuning procedure of the first machine learning model, and the UE may perform the tuning procedure of the first machine learning model to obtain a second set of parameters associated with the first machine learning model based on the capability of the UE to perform the tuning procedure of the first machine learning model. The capability of the UE to perform the tuning procedure may be one of an online tuning capability or an offline tuning capability.

### CROSS REFERENCE

The present application is a 371 national stage filing of International PCT Application No. PCT/CN2022/133369 by SONG et al. entitled “MODEL TUNING FOR CROSS NODE MACHINE LEARNING,” filed Nov. 22, 2022, which is assigned to the assignee hereof, and which is expressly incorporated by reference in its entirety herein.

### FIELD OF TECHNOLOGY

The following relates to wireless communications, including model tuning for cross node machine learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support model tuning for cross node machine learning. Generally, the described techniques enable a user equipment (UE) to autonomously perform a tuning (e.g., fine tuning) procedure for a machine learning model used in communications between the UE and a network entity. For example, the UE may receive data samples (e.g., a training data set) from the network entity to train the machine learning model. The UE may transmit a capability message to the network entity, and the capability message may indicate whether the UE may autonomously perform the tuning procedure. The UE may generate a second training data set based on the tuning procedure, and the UE or the network entity may use the second training data set to perform a tuning procedure of a second machine learning model.

A method for wireless communication at a UE is described. The method may include obtaining data samples for a first machine learning model associated with a task at the UE, where a first set of parameters is associated with the first machine learning model, transmitting a capability message indicating a capability of the UE to perform a tuning procedure of the first machine learning model, performing the tuning procedure of the first machine learning model to obtain a second set of parameters associated with the first machine learning model based on the capability of the UE to perform the tuning procedure of the first machine learning model, and transmitting, to a network entity, a message indicating at least a portion of the second set of parameters based on performing the tuning procedure of the first machine learning model.

An apparatus for wireless communication at a UE is described. The apparatus may include a processor, memory coupled with the processor, and instructions stored in the memory. The instructions may be executable by the processor to cause the apparatus to obtain data samples for a first machine learning model associated with a task at the UE, where a first set of parameters is associated with the first machine learning model, transmit a capability message indicating a capability of the UE to perform a tuning procedure of the first machine learning model, perform the tuning procedure of the first machine learning model to obtain a second set of parameters associated with the first machine learning model based on the capability of the UE to perform the tuning procedure of the first machine learning model, and transmit, to a network entity, a message indicating at least a portion of the second set of parameters based on performing the tuning procedure of the first machine learning model.

Another apparatus for wireless communication at a UE is described. The apparatus may include means for obtaining data samples for a first machine learning model associated with a task at the UE, where a first set of parameters is associated with the first machine learning model, means for transmitting a capability message indicating a capability of the UE to perform a tuning procedure of the first machine learning model, means for performing the tuning procedure of the first machine learning model to obtain a second set of parameters associated with the first machine learning model based on the capability of the UE to perform the tuning procedure of the first machine learning model, and means for transmitting, to a network entity, a message indicating at least a portion of the second set of parameters based on performing the tuning procedure of the first machine learning model.

A non-transitory computer-readable medium storing code for wireless communication at a UE is described. The code may include instructions executable by a processor to obtain data samples for a first machine learning model associated with a task at the UE, where a first set of parameters is associated with the first machine learning model, transmit a capability message indicating a capability of the UE to perform a tuning procedure of the first machine learning model, perform the tuning procedure of the first machine learning model to obtain a second set of parameters associated with the first machine learning model based on the capability of the UE to perform the tuning procedure of the first machine learning model, and transmit, to a network entity, a message indicating at least a portion of the second set of parameters based on performing the tuning procedure of the first machine learning model.

In some examples of the method, apparatuses, and non-transitory computer-readable medium described herein, the first machine learning model includes an encoder portion of a second machine learning model and a third machine learning model includes a decoder portion of the second machine learning model.

In some examples of the method, apparatuses, and non-transitory computer-readable medium described herein, performing the tuning procedure of the first machine learning model may include operations, features, means, or instructions for receiving a set of parameters associated with a loss function.

Some examples of the method, apparatuses, and non-transitory computer-readable medium described herein may further include operations, features, means, or instructions for transmitting a message associated with a forward propagation procedure.

Some examples of the method, apparatuses, and non-transitory computer-readable medium described herein may further include operations, features, means, or instructions for receiving a message associated with a backward propagation procedure for adjusting parameters associated with an encoder, where the message indicates a gradient associated with the loss function and updating the parameters associated with the encoder based on the message.

Some examples of the method, apparatuses, and non-transitory computer-readable medium described herein may further include operations, features, means, or instructions for receiving the set of parameters associated with the loss function and updating parameters associated with the decoder portion of the second machine learning model based on the set of parameters.

In some examples of the method, apparatuses, and non-transitory computer-readable medium described herein, transmitting the capability message may include operations, features, means, or instructions for transmitting an indication of a set of machine learning models supported by the UE.

In some examples of the method, apparatuses, and non-transitory computer-readable medium described herein, the task includes a Channel State Information (CSI) feedback task.

In some examples of the method, apparatuses, and non-transitory computer-readable medium described herein, performing the tuning procedure of the first machine learning model may include operations, features, means, or instructions for updating parameters associated with an encoder, parameters associated with a decoder, or both using the second set of parameters.

In some examples of the method, apparatuses, and non-transitory computer-readable medium described herein, performing the tuning procedure of the first machine learning model may include operations, features, means, or instructions for performing an online tuning procedure.

In some examples of the method, apparatuses, and non-transitory computer-readable medium described herein, performing the online tuning procedure of the first machine learning model may include operations, features, means, or instructions for updating the second set of parameters associated with the encoder using the second set of parameters for the first machine learning model in performing the task.

In some examples of the method, apparatuses, and non-transitory computer-readable medium described herein, performing the tuning procedure of the first machine learning model may include operations, features, means, or instructions for performing an offline tuning procedure.

In some examples of the method, apparatuses, and non-transitory computer-readable medium described herein, performing the offline tuning procedure of the first machine learning model may include operations, features, means, or instructions for updating the second set of parameters associated with the encoder using the first set of parameters for the first machine learning model in performing the task.

Some examples of the method, apparatuses, and non-transitory computer-readable medium described herein may further include operations, features, means, or instructions for transmitting a third indication to the network entity, where the third indication indicates an availability of a second encoder, where the second encoder may be associated with performing the offline tuning procedure.

In some examples of the method, apparatuses, and non-transitory computer-readable medium described herein, performing the tuning procedure may include operations, features, means, or instructions for receiving a first indication from the network entity associated with performing the tuning procedure of the first machine learning model, where the first indication includes an activation status or an allowed status and transmitting a second indication to the network entity in response to the first indication, where the second indication includes an activation indication associated with starting to perform the tuning procedure or a deactivation indication associated with stopping the tuning procedure.

Some examples of the method, apparatuses, and non-transitory computer-readable medium described herein may further include operations, features, means, or instructions for transmitting an activation request to the network entity, where receiving the first indication may be based on the activation request.

Some examples of the method, apparatuses, and non-transitory computer-readable medium described herein may further include operations, features, means, or instructions for receiving a fourth indication from the network entity, where the fourth indication includes a deactivation indication associated with stopping the tuning procedure.

In some examples of the method, apparatuses, and non-transitory computer-readable medium described herein, performing the tuning procedure of the first machine learning model may include operations, features, means, or instructions for updating parameters associated with an encoder, parameters associated with a decoder, or both using the second set of parameters based on a gradient associated with the first set of parameters and the second set of parameters.

In some examples of the method, apparatuses, and non-transitory computer-readable medium described herein, updating parameters associated with an encoder, parameters associated with a decoder, or both may include operations, features, means, or instructions for receiving a set of parameters associated with a loss function and transmitting a message associated with a forward propagation procedure.

Some examples of the method, apparatuses, and non-transitory computer-readable medium described herein may further include operations, features, means, or instructions for receiving a message associated with a backward propagation procedure for adjusting parameters associated with an encoder, parameters associated with a decoder, or both, where the message indicates a gradient associated with the loss function and updating the parameters associated with the encoder, parameters associated with a decoder, or both based on the message.

In some examples of the method, apparatuses, and non-transitory computer-readable medium described herein, the UE receives the indication of the first set of parameters via broadcast signaling, dedicated signaling, or both.

A method for wireless communication at a UE with a first set of parameters associated with a first machine learning model for a task is described. The method may include transmitting, to a network entity, a capability message indicating a capability of the UE to perform a tuning procedure of a first machine learning model, where a first set of parameters is associated with the first machine learning model, performing the tuning procedure of the first machine learning model to obtain a second set of parameters associated with the first machine learning model based on the capability of the UE to perform the tuning procedure of the first machine learning model, transmitting, to a network entity, a message indicating the second set of parameters based on performing the tuning procedure of the first machine learning model, receiving an allowed status indication from the network entity associated with the second set of parameters, performing the task using the first set of parameters associated with the first machine learning model or the second set of parameters associated with the first machine learning model based on the received allowed status indication, receiving a disallowed status indication from the network entity associated with the second set of parameters, and performing the task using the first set of parameters associates with the first machine learning model based on the received disallowed status indication.

An apparatus for wireless communication at a UE with a first set of parameters associated with a first machine learning model for a task is described. The apparatus may include a processor, memory coupled with the processor, and instructions stored in the memory. The instructions may be executable by the processor to cause the apparatus to transmit, to a network entity, a capability message indicating a capability of the UE to perform a tuning procedure of a first machine learning model, where a first set of parameters is associated with the first machine learning model, perform the tuning procedure of the first machine learning model to obtain a second set of parameters associated with the first machine learning model based on the capability of the UE to perform the tuning procedure of the first machine learning model, transmit, to a network entity, a message indicating the second set of parameters based on performing the tuning procedure of the first machine learning model, receive an allowed status indication from the network entity associated with the second set of parameters, perform the task using the first set of parameters associated with the first machine learning model or the second set of parameters associated with the first machine learning model based on the received allowed status indication, receive a disallowed status indication from the network entity associated with the second set of parameters, and perform the task using the first set of parameters associates with the first machine learning model based on the received disallowed status indication.

Another apparatus for wireless communication at a UE with a first set of parameters associated with a first machine learning model for a task is described. The apparatus may include means for transmitting, to a network entity, a capability message indicating a capability of the UE to perform a tuning procedure of a first machine learning model, where a first set of parameters is associated with the first machine learning model, means for performing the tuning procedure of the first machine learning model to obtain a second set of parameters associated with the first machine learning model based on the capability of the UE to perform the tuning procedure of the first machine learning model, means for transmitting, to a network entity, a message indicating the second set of parameters based on performing the tuning procedure of the first machine learning model, means for receiving an allowed status indication from the network entity associated with the second set of parameters, means for performing the task using the first set of parameters associated with the first machine learning model or the second set of parameters associated with the first machine learning model based on the received allowed status indication, means for receiving a disallowed status indication from the network entity associated with the second set of parameters, and means for performing the task using the first set of parameters associates with the first machine learning model based on the received disallowed status indication.

A non-transitory computer-readable medium storing code for wireless communication at a UE with a first set of parameters associated with a first machine learning model for a task is described. The code may include instructions executable by a processor to transmit, to a network entity, a capability message indicating a capability of the UE to perform a tuning procedure of a first machine learning model, where a first set of parameters is associated with the first machine learning model, perform the tuning procedure of the first machine learning model to obtain a second set of parameters associated with the first machine learning model based on the capability of the UE to perform the tuning procedure of the first machine learning model, transmit, to a network entity, a message indicating the second set of parameters based on performing the tuning procedure of the first machine learning model, receive an allowed status indication from the network entity associated with the second set of parameters, perform the task using the first set of parameters associated with the first machine learning model or the second set of parameters associated with the first machine learning model based on the received allowed status indication, receive a disallowed status indication from the network entity associated with the second set of parameters, and perform the task using the first set of parameters associates with the first machine learning model based on the received disallowed status indication.

Some examples of the method, apparatuses, and non-transitory computer-readable medium described herein may further include operations, features, means, or instructions for autonomously determining whether to perform the task using the first set of parameters associated with the first machine learning model or using the second set of parameters associated with the first machine learning model based at least in part on the received allowed status indication.

A method for wireless communication at a UE with a first set of parameters associated with a first machine learning model for a task is described. The method may include transmitting, to a network entity, a capability message indicating a capability of the UE to perform an online tuning procedure of the first machine learning model, where a first set of parameters is associated with the first machine learning model, receiving a first indication from the network entity associated with the online tuning procedure, where the first indication includes an activation status, or an allowed status, and performing the online tuning procedure of the first machine learning model to obtain a second set of parameters associated with the first machine learning model based on the capability of the UE to perform the tuning procedure of the first machine learning model and the received allowed status.

An apparatus for wireless communication at a UE with a first set of parameters associated with a first machine learning model for a task is described. The apparatus may include a processor, memory coupled with the processor, and instructions stored in the memory. The instructions may be executable by the processor to cause the apparatus to transmit, to a network entity, a capability message indicating a capability of the UE to perform an online tuning procedure of the first machine learning model, where a first set of parameters is associated with the first machine learning model, receive a first indication from the network entity associated with the online tuning procedure, where the first indication includes an activation status, or an allowed status, and perform the online tuning procedure of the first machine learning model to obtain a second set of parameters associated with the first machine learning model based on the capability of the UE to perform the tuning procedure of the first machine learning model and the received allowed status.

Another apparatus for wireless communication at a UE with a first set of parameters associated with a first machine learning model for a task is described. The apparatus may include means for transmitting, to a network entity, a capability message indicating a capability of the UE to perform an online tuning procedure of the first machine learning model, where a first set of parameters is associated with the first machine learning model, means for receiving a first indication from the network entity associated with the online tuning procedure, where the first indication includes an activation status, or an allowed status, and means for performing the online tuning procedure of the first machine learning model to obtain a second set of parameters associated with the first machine learning model based on the capability of the UE to perform the tuning procedure of the first machine learning model and the received allowed status.

A non-transitory computer-readable medium storing code for wireless communication at a UE with a first set of parameters associated with a first machine learning model for a task is described. The code may include instructions executable by a processor to transmit, to a network entity, a capability message indicating a capability of the UE to perform an online tuning procedure of the first machine learning model, where a first set of parameters is associated with the first machine learning model, receive a first indication from the network entity associated with the online tuning procedure, where the first indication includes an activation status, or an allowed status, and perform the online tuning procedure of the first machine learning model to obtain a second set of parameters associated with the first machine learning model based on the capability of the UE to perform the tuning procedure of the first machine learning model and the received allowed status.

A method for wireless communication at a network entity is described. The method may include receiving, from a UE, a capability message indicating a capability of the UE to perform a tuning procedure of a first machine learning model associated with a first set of parameters at the UE and receiving, from the UE, a message indicating at least a portion of a second set of parameters.

An apparatus for wireless communication at a network entity is described. The apparatus may include a processor, memory coupled with the processor, and instructions stored in the memory. The instructions may be executable by the processor to cause the apparatus to receive, from a UE, a capability message indicating a capability of the UE to perform a tuning procedure of a first machine learning model associated with a first set of parameters at the UE and receive, from the UE, a message indicating at least a portion of a second set of parameters.

Another apparatus for wireless communication at a network entity is described. The apparatus may include means for receiving, from a UE, a capability message indicating a capability of the UE to perform a tuning procedure of a first machine learning model associated with a first set of parameters at the UE and means for receiving, from the UE, a message indicating at least a portion of a second set of parameters.

A non-transitory computer-readable medium storing code for wireless communication at a network entity is described. The code may include instructions executable by a processor to receive, from a UE, a capability message indicating a capability of the UE to perform a tuning procedure of a first machine learning model associated with a first set of parameters at the UE and receive, from the UE, a message indicating at least a portion of a second set of parameters.

In some examples of the method, apparatuses, and non-transitory computer-readable medium described herein, the first machine learning model includes an encoder portion of a second machine learning model and a third machine learning model includes a decoder portion of the second machine learning model.

In some examples of the method, apparatuses, and non-transitory computer-readable medium described herein, receiving the capability message may include operations, features, means, or instructions for receiving an indication of a set of machine learning models supported by the UE.

Some examples of the method, apparatuses, and non-transitory computer-readable medium described herein may further include operations, features, means, or instructions for receiving the message may be associated with receiving channel state information feedback.

Some examples of the method, apparatuses, and non-transitory computer-readable medium described herein may further include operations, features, means, or instructions for transmitting, to the UE, a first indication associated with performing a tuning procedure of the first machine learning model, where the first indication includes an activation status or an allowed status and receiving, from the UE, a second indication in response to the first indication, where the second indication includes an activation indication associated with starting to perform the tuning procedure or a deactivation indication associated with stopping the tuning procedure.

Some examples of the method, apparatuses, and non-transitory computer-readable medium described herein may further include operations, features, means, or instructions for receiving, from the UE, an activation request, where transmitting the first indication may be based on the activation request.

Some examples of the method, apparatuses, and non-transitory computer-readable medium described herein may further include operations, features, means, or instructions for transmitting, to the UE, a third indication, where the third indication includes a deactivation indication associated with stopping the tuning procedure.

### BRIEF DESCRIPTION OF THE DRAWINGS

FIG. 1 illustrates an example of a wireless communications system that supports model tuning for cross node machine learning in accordance with one or more aspects of the present disclosure.

FIG. 2 illustrates an example of a wireless communications system that supports model tuning for cross node machine learning in accordance with one or more aspects of the present disclosure.

FIG. 3 illustrates an example of a process flow that supports model tuning for cross node machine learning in accordance with one or more aspects of the present disclosure.

FIG. 4 illustrates an example of a process flow that supports model tuning for cross node machine learning in accordance with one or more aspects of the present disclosure.

FIG. 5 illustrates an example of a process flow that supports model tuning for cross node machine learning in accordance with one or more aspects of the present disclosure.

FIG. 6 illustrates an example of a process flow that supports model tuning for cross node machine learning in accordance with one or more aspects of the present disclosure.

FIG. 7 illustrates an example of a process flow that supports model tuning for cross node machine learning in accordance with one or more aspects of the present disclosure.

FIG. 8 illustrates an example of a process flow that supports model tuning for cross node machine learning in accordance with one or more aspects of the present disclosure.

FIGS. 9 and 10 illustrate block diagrams of devices that support model tuning for cross node machine learning in accordance with one or more aspects of the present disclosure.

FIG. 11 illustrates a block diagram of a communications manager that supports model tuning for cross node machine learning in accordance with one or more aspects of the present disclosure.

FIG. 12 illustrates a diagram of a system including a device that supports model tuning for cross node machine learning in accordance with one or more aspects of the present disclosure.

FIGS. 13 and 14 illustrate block diagrams of devices that support model tuning for cross node machine learning in accordance with one or more aspects of the present disclosure.

FIG. 15 illustrates a block diagram of a communications manager that supports model tuning for cross node machine learning in accordance with one or more aspects of the present disclosure.

FIG. 16 illustrates a diagram of a system including a device that supports model tuning for cross node machine learning in accordance with one or more aspects of the present disclosure.

FIGS. 17 through 21 illustrate flowcharts showing methods that support model tuning for cross node machine learning in accordance with one or more aspects of the present disclosure.

### DETAILED DESCRIPTION

In some wireless communications network, a user equipment (UE) may use data samples (e.g., a training data set) to train a machine learning model used for communications with the UE and a network entity. In some examples, the UE may perform a tuning (e.g., fine tuning) procedure of the training data set to improve the performance of the machine learning model and the performance of an encoder (e.g., at the UE) and a decoder (e.g., at a network entity). For example, the UE may have a baseline machine learning model (e.g., a first machine learning model), and the network entity may enable or instruct, via signaling, the UE to perform a tuning procedure of the first machine learning model using the training data set. However, the network entity transmitting signaling to trigger the tuning procedure at the UE may result in increased latency and overhead.

Techniques, systems, and devices herein enable a UE to perform model tuning for cross node machine learning. Generally, the described techniques enable a UE to autonomously perform a tuning (e.g., fine tuning) procedure for a machine learning model used in communications between the UE and a network entity. For example, the UE may transmit a capability message to the network entity that indicates whether the UE may autonomously perform the tuning procedure. The tuning procedure may be one of an online tuning procedure or an offline tuning procedure. The UE may generate a second training data set based on the tuning procedure, and the UE or the network entity may use the second training data set to perform a tuning procedure of a second machine learning model for use at the corresponding encoder, decoder, or both. The UE may generate the second training data set from the received reference signals from the network entity.

Aspects of the disclosure are initially described in the context of wireless communications systems. Aspects of the disclosure are further illustrated by process flows. Aspects of the disclosure are further illustrated by and described with reference to apparatus diagrams, system diagrams, and flowcharts that relate to model tuning for cross node machine learning.

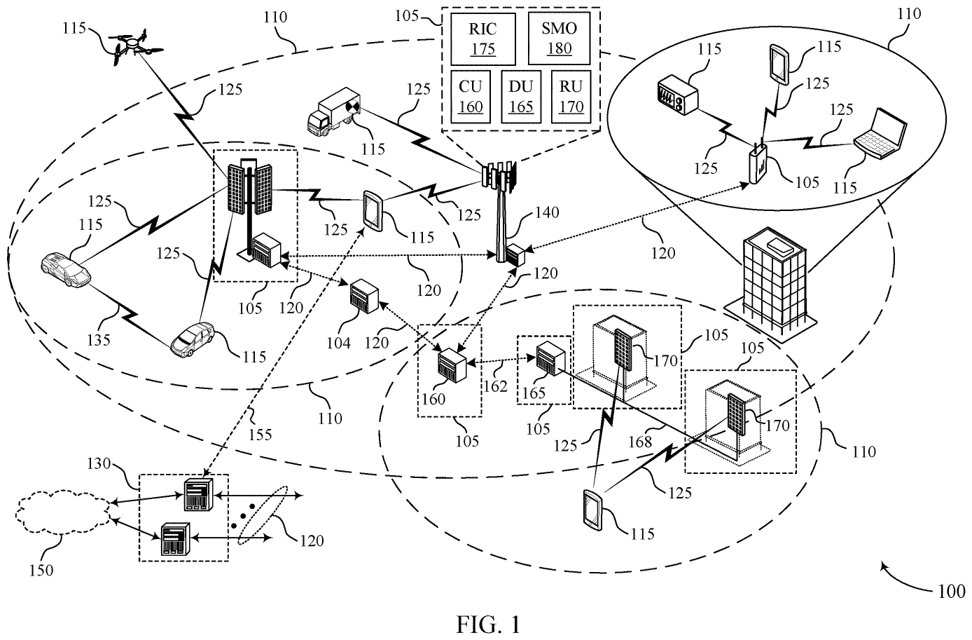

FIG. 1 illustrates an example of a wireless communications system 100 that supports model tuning for cross node machine learning in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, 5G-Advanced network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support model tuning for cross node machine learning as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR, 5G-Advanced). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Wireless communications system 100 may implement a cross node machine learning mode tuning (e.g., fine tuning) procedure for a first device, such as a UE 115, to communicate with a second device, such as a network entity 105. In some examples, the UE 115 may perform a tuning procedure of a machine learning model based on data samples (e.g., a first data set). The machine learning model may be a first machine learning model (e.g., a baseline machine learning model) configured at the UE 115 by a network entity 105 (e.g., deployed at the UE 115 or indicated to the UE 115 via a message transmitted by the network entity 105). The first data set may include a set of data samples collected by the UE 115, the network entity 105, or both. The training data set used for the first machine learning model may be associated with a first distribution of samples, and the set of collected data samples may be associated with a second distribution of samples. The difference between the distributions of samples (e.g., a magnitude of discrepancy between the distributions) may be used to improve the performance, such as the interference performance, and accuracy of the first machine learning model.

For example, the UE 115 may use the first data set to perform the tuning procedure of the first machine learning model, and the difference in the distributions included in the first data set may improve the machine learning model. The UE 115 may perform encoder tuning, decoder tuning, or both using the first data set, where the encoder is located at the UE 115 and the decoder is located at the network entity 105. For example, the tuning procedure may be defined by Equations 1 and 2:

$$z = {f}_{θ} ( v ) \qquad ( 1 )$$

$$\hat{v} = {g}_{φ} ( z ) \qquad ( 2 )$$

where f_{θ} corresponds to the machine learning model of the encoder parameterized by θ at the UE 115, z corresponds to an encoded channel state, v corresponds to a channel state at the encoder, g_{φ} corresponds to a machine learning model of the decoder parameterized by φ at the network entity 105, and \hat{v} corresponds to a decoded channel state. The performance of the machine learning model may be defined by a loss function. For example, the loss function may be defined by Equation 3 and an example of the loss function may be defined by Equation 4:

$$L = {L}_{Fid} + {L}_{Reg} \qquad ( 3 )$$

$$L = {‖ ( v - \hat{v} ) ‖}_{2}^{2} + α {‖ θ ‖}_{2}^{2} + β {‖ φ ‖}_{2}^{2} \qquad ( 4 )$$

where L corresponds to an overall performance of the machine learning model,

$${‖ ( v - \hat{v} ) ‖}_{2}^{2}$$

corresponds to a fidelity performance of the machine learning model, and

$$α {‖ θ ‖}_{2}^{2} + β {‖ φ ‖}_{2}^{2}$$

corresponds to a regularization performance of the machine learning model.

For example, the UE 115 may encode the channel state using the machine learning model using the encoder, and the UE 115 may report the encoded channel state to the network entity 105. The network entity 105 may reconstruct the decoded channel state based on the received encoded channel state. The quality of the decoded channel state may be associated with the tuning procedure at the UE. In some examples, the network entity 105 may enable for the UE 115 to use the encoder to perform the tuning procedure (e.g., the network entity 105 may transmit signaling that allows the UE 115 to perform the tuning procedure). In this example, the network entity 105 may tune the encoder and the decoder jointly (e.g., as an encoder and decoder pair) using the first data set or the decoder alone. Additionally, or alternatively, the network entity 105 may request for the UE 115 to tune the encoder using the first data set. However, the signaling enabling the UE 115 to tune the encoder may result in increased latency and decreased efficiency in communications.

According to techniques herein, the UE 115 may autonomously perform the tuning procedure using the first data set to generate a second machine learning model for use at the UE 115, the network entity 105, or both. For example, the UE 115 may be allowed to tune the encoder without permission or explicit signaling from the network entity. As such, the UE 115 may tune the encoder using information that it has about the decoder. If the UE 115 done not share the autonomously tuned encoder information with the network entity 105, the network entity 105 may tune the decoder using a stable encoder. In some examples, the UE 115 may additionally tune the decoder and communicate the information to the network entity 105, or alternatively, the UE 115 may not have information about the decoder and may be unable to tune the decoder.

In some examples, the UE 115 may transmit a capability message to the network entity. In some examples, the capability message may be UE capability signal or message that includes a list of supported encoders (e.g., if multiple encoders are available for a given task). Additionally, or alternatively, the UE 115 may transmit machine learning model selection signaling to the network entity 105 which indicates a machine learning model selected or to be selected by the UE 115 (e.g., if multiple machine learning models are available at the UE 115). In some other examples, the capability message may indicate whether the UE 115 may autonomously perform the tuning procedure. The tuning procedure may be one of an online tuning procedure or an offline tuning procedure. An offline tuning procedure may involve the UE 115 training a separate instance of an encoder or decoder while leaving the encoder or decoder for inference untouched during the training. In some examples, the separate instance of the encoder or decoder may be stored at the UE 115 or in a cloud storage (e.g., a network-accessible server that stores data). Offline tuning can be UE-specific or specific to a manufacturer or vendor of the UE 115. An online tuning procedure may involve training an encoder or decoder used for interference. Online tuning may be done when a UE 115 requests activation of the online tuning procedure. In some cases, however, the UE 115 may reject an activation command from the network entity 105, or the network entity 105 may request UE 115 to fallback to a baseline encoder. The UE 115 may generate a second training data set based on the tuning procedure, and the UE 115 or the network entity 105 may use the second training data set to perform a tuning procedure of a second machine learning model for use at the corresponding encoder, decoder, or both.

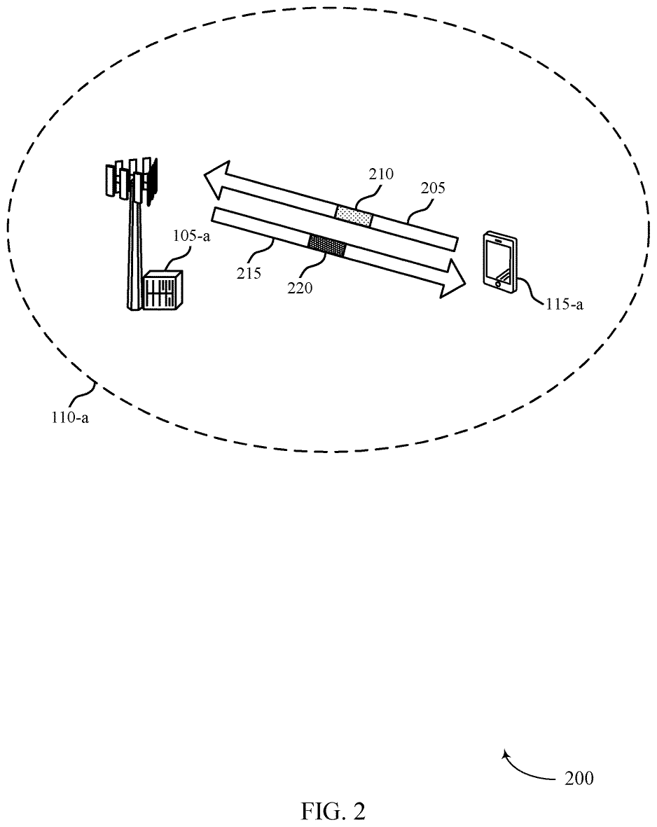

FIG. 2 illustrates an example of a wireless communications system 200 that supports model tuning for cross node machine learning in accordance with one or more aspects of the present disclosure. In some examples, wireless communications system 200 may implement aspects of wireless communications system 100. For example, wireless communications system 200 includes a network entity 105-a and a UE 115-a in a coverage area 110-a, which may be examples of the corresponding devices described with reference to FIG. 1.

In some examples, the network entity 105-a may enable for the UE 115-a to use the encoder to perform the tuning procedure (e.g., the network entity 105 may transmit signaling that allows the UE 115-a to perform the tuning procedure). Additionally, or alternatively, the network entity 105-a may request for the UE 115-a to tune the encoder using the first data set. However, the signaling enabling the UE 115-a to tune the encoder may result in increased latency and decreased efficiency in communications.

In some examples, the UE 115-a may autonomously perform the tuning procedure using the first data set to generate a second machine learning model (e.g., an updated machine learning model) for use at the UE 115-a, the network entity 105-a, or both. For example, the UE 115-a may tune the encoder, and the network entity 105-a may tune the decoder using the encoded channel state of the trained encoder. In some examples, the UE 115-a may provide signaling to the network entity 105-a to tune a decoder at the network entity 105-a.

Wireless communications system 200 may support procedures to perform a tuning procedure of a machine learning model. For example, the UE 115-a may use an uplink communications link 205 to transmit data samples 210 (e.g., a first data set) to the network entity 105-a. The network entity 105-a may collect the data samples 210 from a group of UEs to perform a tuning procedure of the machine learning model. The network entity 105-a may use a downlink communications link 215 to transmit a baseline update 220 to the UE 115-a, which may be transmitted via broadcast signaling or dedicated signaling for the UE 115-a. The baseline update 220 may be an update of a first machine learning model (e.g., the baseline machine learning model) at the UE 115-a. The UE 115-a may use the baseline update 220 to tune the first machine learning model and to perform communications with the network entity 105-a using the updated machine learning model (e.g., a second machine learning model).

In some examples, the UE 115-a may refrain from performing a tuning procedure of the encoder and the decoder, and the network entity 105-a may perform the tuning procedure for the encoder and the decoder. For example, the network entity 105-a may use information from multiple UEs 115 to collect data samples 210, and signaling for the UE 115-a to perform the tuning procedure (e.g., back propagation signaling) may not be utilized. As such, the network entity 105-a may use the data samples 210 to update the encoder, and the network entity 105-a may transmit channel state information (e.g., baseline update 220) to the UE 115-a. The network entity 105-a may perform the tuning procedure opportunistically (e.g., when the network is under-utilized).

In this example, the network entity 105-a may use one or more encoder and decoder pairs, which may be custom pairs that are undefined in a set of operating procedure defined by an operating standard. The network entity 105-a may also collect data samples 210 (e.g., channel state information (CSI) data samples) to train or tune the one or more encoder and decoder pairs. The network entity 105-a may transmit the baseline update 220 to the UE 115-a via broadcast signaling or dedicated signaling, which may indicate the updated encoder and decoder pair. The baseline update 220 may include encoder coefficients, decoder coefficients, or both. In another example, the baseline update 220 may include a pointer (e.g., a uniform resource locator (URL)) that indicates the encoder coefficients, the decoder coefficients, or both.

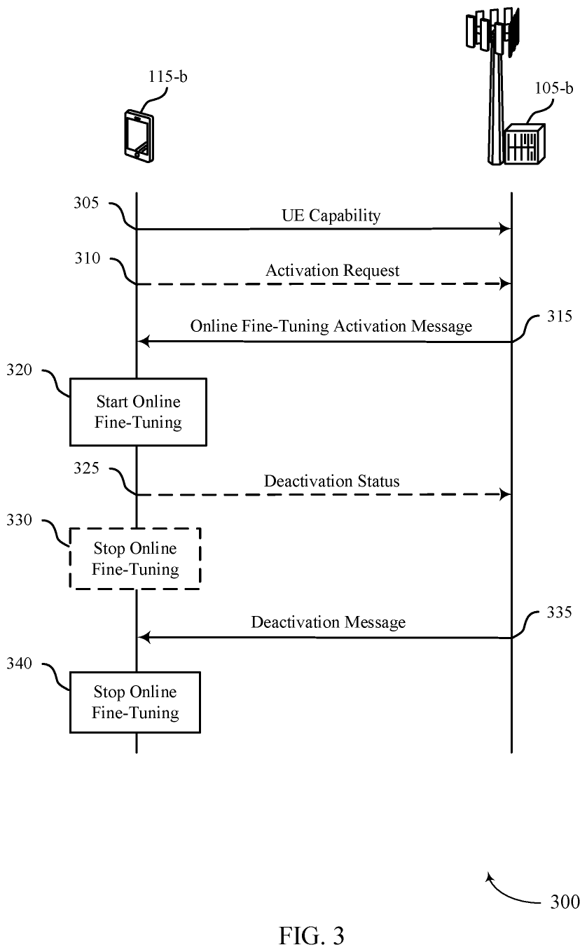

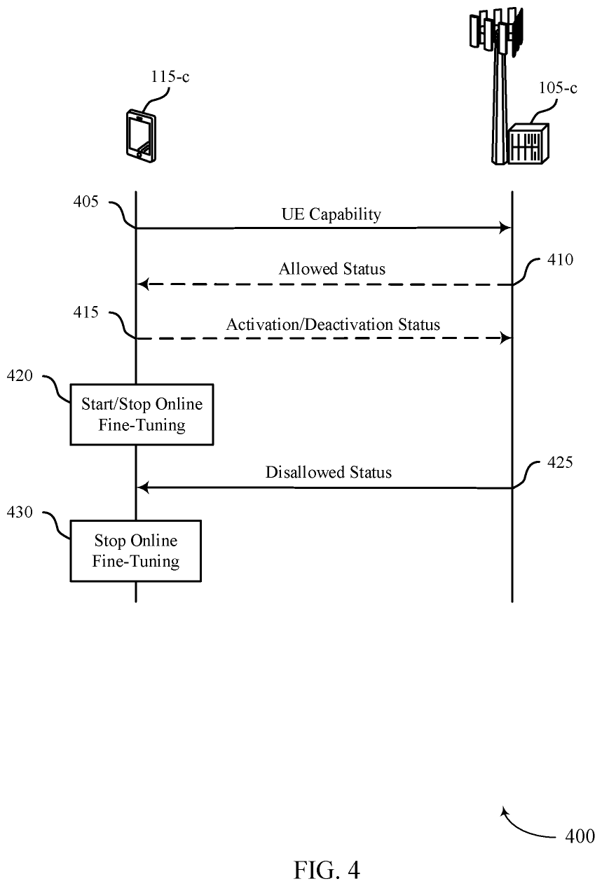

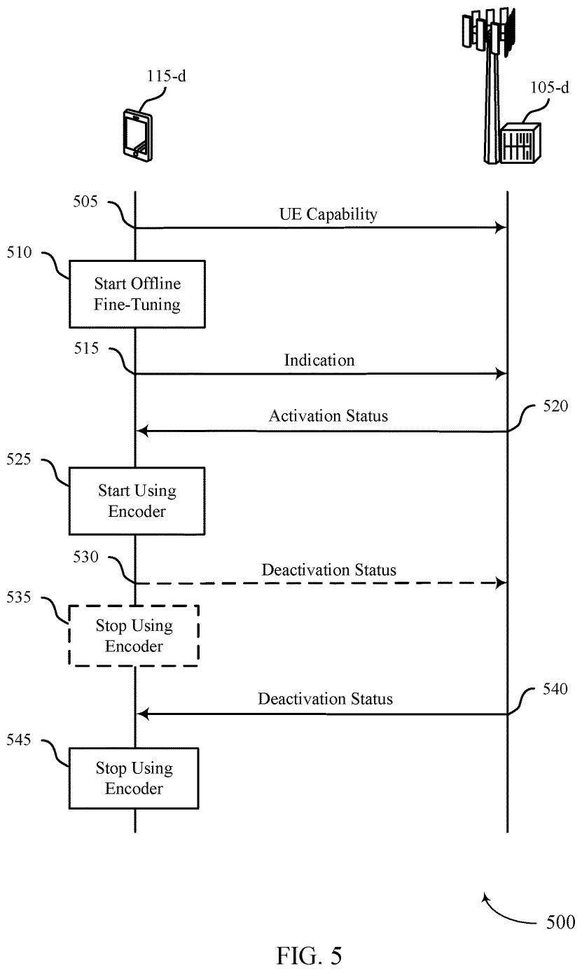

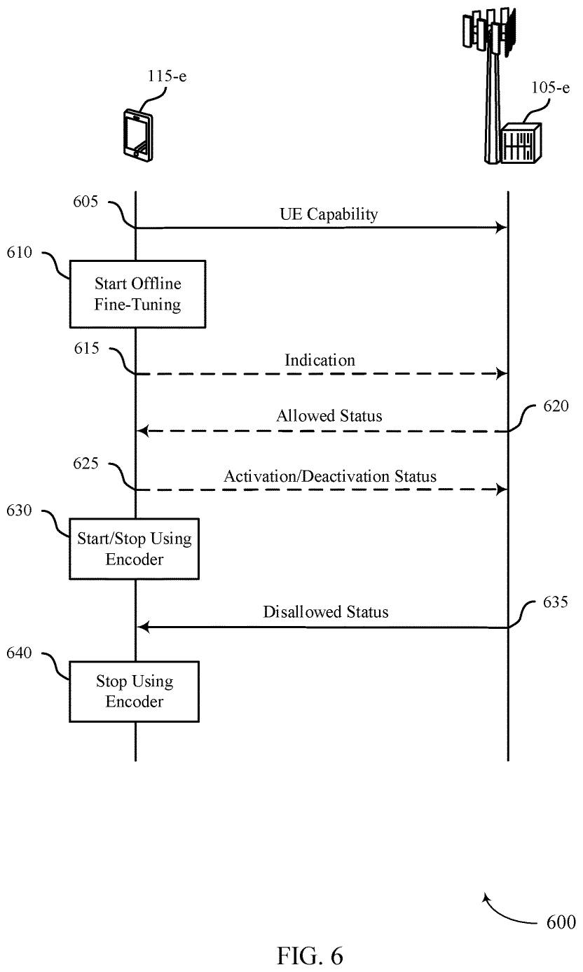

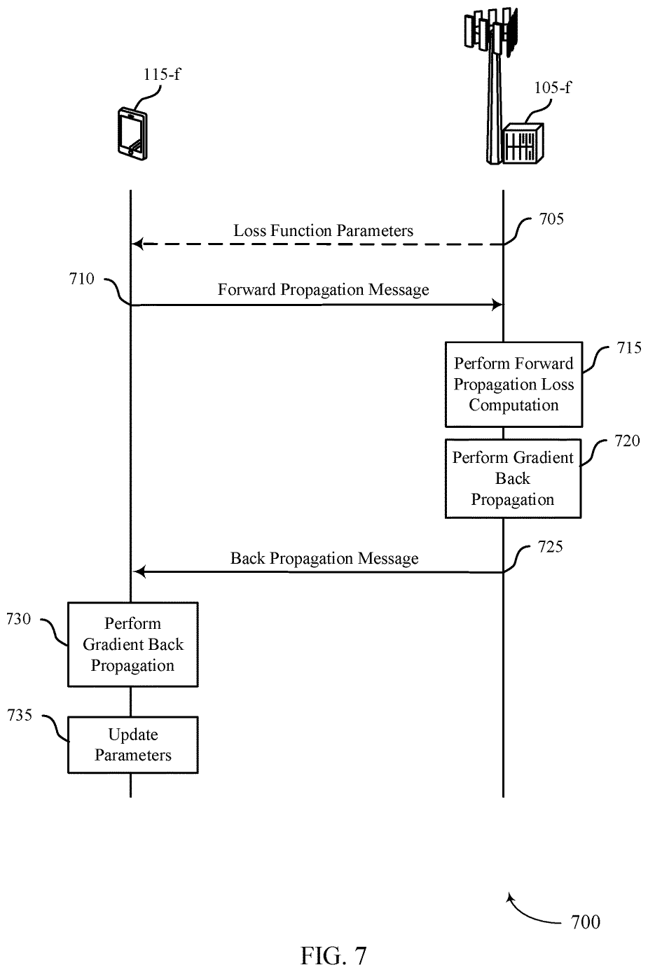

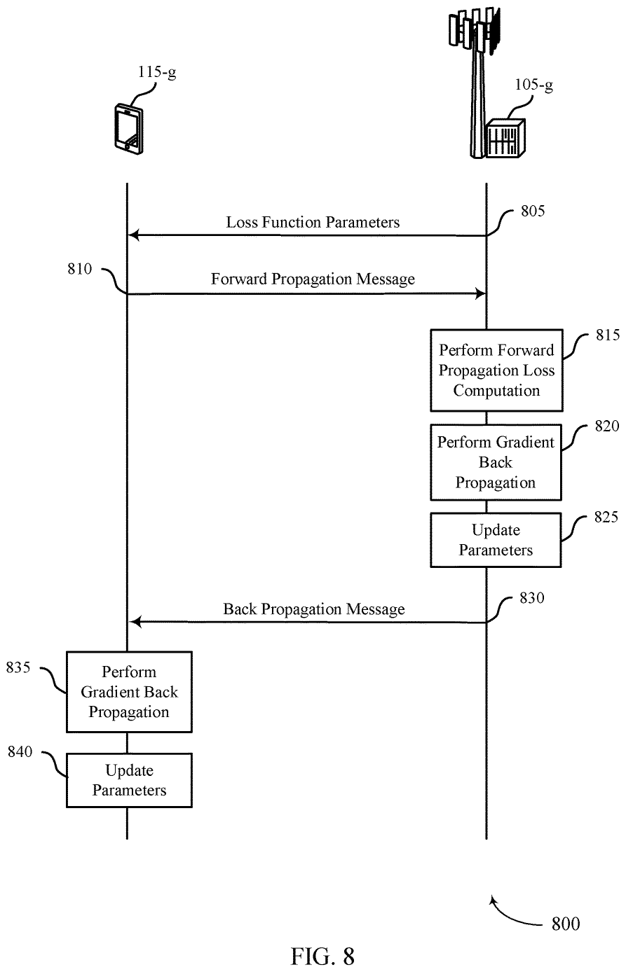

In some examples, the UE 115-a may perform an online tuning procedure, and the network entity 105-a may refrain from performing the tuning procedure, as described further in FIG. 3. In some examples, the UE 115-a may autonomously perform the online tuning procedure, and the network entity 105-a may refrain from performing the tuning procedure, as described further in FIG. 4. In some examples, the UE 115-a may perform the offline tuning procedure, and the network entity 105-a may refrain from performing the tuning procedure, as described further in FIG. 5. In some examples, the UE 115-a may autonomously perform the offline tuning procedure, and the network entity 105-a may refrain from performing the tuning procedure, as described further in FIG. 6. In some examples, the UE 115-a may perform the tuning procedure, and the UE 115-a may not have information regarding the decoder of the network entity 105-a, as described further in FIG. 7. In some examples, the UE 115-a and the network entity 105-a may jointly perform the online tuning procedure of both the encoder and the decoder, as described further in FIG. 8.

In some examples, a baseline machine learning model may be used by the UE 115-a. A baseline model may be an example of a model defined in a communication standard, indicated by the network entity 105-a (e.g., downloaded by the UE 115-a or transmitted from the network entity 105-a to the UE 115-a), or may be deployed by the vendor or manufacturer of the UE 115-a. A baseline model may be fixed or updated over time.

A machine learning model may be tuned or fine-tuned by training the model with a training dataset, which may be collected by the UE 115-a or network entity 105-a. The tuning may improve the inference performance depending on the magnitude of the discrepancy between a distribution of the training dataset and a distribution of data samples observed by the UE 115-a or the network entity 105-a. A tuning procedure may involve forward propagation in which a first device (e.g., a UE 115-a) transmits information to a second device (e.g., a network entity 105-a) which is used by the second device to tune a machine learning model at the second device (which may be used for communication between the first and second devices). A tuning procedure may be a fine tuning procedure in which both forward propagation and backward propagation is used. Backward propagation may involve the transmission of information from the second device back to the first device after the first device provides some initial information to the second device. For example, UE 115-a may provide the information associated with forward propagation to the network entity 105-a, which may be (v, z) pairs, where v represents channel state information at the UE 115-a (e.g., a CSI encoder or a channel state feedback (CSF) encoder). In some cases, the UE 115-a may provide information about the channel between the UE 115-a and the network entity 105-a, which is represented by z. For instance, the UE 115-a may encode information about the channel state v into z using an encoder at the UE 115-a.

After the UE 115-a transmits information associated with the forward propagation, the network entity 105-a may transmit information associated with the backward propagation to the UE 115-a. For example, the network entity 105-a may reconstruct the channel state \hat{v} from z using a decoder at the network entity 105-a. The network entity 105-a may transmit information about the gradient of the channel (such as ∇_{z}L where L denotes the loss function). The UE 115-a may update the encoder parameters (θ) based on the gradient. That is, the UE 115-a may update one or more parameters from a set of baseline parameters (θ_{BL}) to a fine-tuned model that utilizes a set of fine-tuned parameters (θ_{FT}). As a result, the encoder may be updated from f_{θ}_{_{BL}}( ) to f_{θ}_{_{BL}}( ). These fine-tuning steps may repeat until a stop criteria occurs (e.g., convergence, fixed number of steps, signaling for stopping).

Fine-tuning may be done opportunistically. For instance, in order to reduce the signaling overhead for exchanging forward propagation and back-propagation, the fine-tuning may be performed when the network is under-utilized (e.g., an allowed signal may be transmitted from the network entity 105-a to the UE 115-a when the network is under-utilized to trigger the UE 115-a to perform fine-tuning. Fine-tuning may be encoder specific, decoder specific, or both.

FIG. 3 illustrates an example of a process flow 300 that supports model tuning for cross node machine learning in accordance with one or more aspects of the present disclosure. In some examples, the process flow 300 may implement aspects of wireless communications system 100 and wireless communications system 200. The process flow 300 may include a UE 115-b and a network entity 105-b, which may be examples of a UE 115 and a network entity 105 as described herein with reference to FIGS. 1 and 2.

The process flow 300 may illustrate an example of techniques which enable a UE 115-b to perform a tuning procedure of a machine learning model. For example, the UE 115-b may perform an online tuning procedure, and the network entity 105-b may refrain from performing the tuning procedure. The UE 115-b and the network entity 105-b may use radio resource control (RRC) signaling, medium access control control element (MAC-CE) signaling, or physical layer signaling (e.g., a downlink control indication (DCI)) to communicate any of the messages or signals described in FIG. 3.

At 305, the UE 115-b may transmit a capability message to the network entity 105-b. The capability message may indicate whether the UE 115-b has the ability to tune (e.g., optimize or modify parameters of) an encoder (e.g., via tuning the encoder using CSI samples collected by the UE 115-b) of the UE 115-b. For example, the UE 115-b may be associated with (e.g., undergo) a certain distribution of wireless channel data samples, and the UE 115-b may tune the encoder using the UE-specific CSI data sample distribution. The capability message may indicate whether the UE 115-b has the capability to perform offline tuning, online tuning, or both.

At 310, in some examples, the UE 115-b may transmit an activation request to the network entity 105-b. The activation request may indicate a request for the UE 115-b to perform the online tuning procedure of the encoder of the UE 115-b, and the activation request may indicate that the UE 115-b has an available encoder for the tuning procedure.

At 315, the network entity 105-b may transmit an activation status to the UE 115-b. In some examples, the network entity 105-b may transmit the activation status in response to the activation request. The activation status may indicate or instruct the UE 115-b to perform the online tuning procedure. The UE 115-b may accept or reject the activation status (e.g., by transmitting a response to the activation status). In some examples, the activation status may request for the UE 115-b to use the baseline machine learning model for the encoder.

At 320, the UE 115-b may start performing the online tuning procedure based on the activation status. The UE 115-b may perform the online tuning procedure if the UE 115-b accepts activation of the online tuning procedure. The online tuning procedure may be associated with the UE 115-b tuning the encoder by updating encoding parameters using data samples that are based on data samples associated with a decoder at the network entity 105-a (e.g., on the fly). In this case, the UE 115-b may not use a separate instance of the decoder or the encoder to perform the online tuning procedure.

At 325, in some examples, the UE 115-b may transmit a deactivation status to the network entity 105-b. The deactivation status may indicate that the UE 115-b may or is to stop performing the online tuning procedure.

At 330, in some examples, the UE 115-b may stop performing the online tuning procedure based on the transmitted deactivation status. Deactivation may be initiated by the UE 115-b or the network entity 105-b.

At 335, the network entity 105-b may transmit a deactivation status to the UE 115-b. The deactivation status may indicate to the UE 115-b to stop performing the online tuning procedure.

At 340, the UE 115-b may stop performing the online tuning procedure based on the received deactivation status.

FIG. 4 illustrates an example of a process flow 400 that supports model tuning for cross node machine learning in accordance with one or more aspects of the present disclosure. In some examples, the process flow 400 may implement aspects of wireless communications system 100 and wireless communications system 200. The process flow 400 may include a UE 115-c and a network entity 105-c, which may be examples of a UE 115 and a network entity 105 as described herein with reference to FIGS. 1 and 2.

The process flow 400 may illustrate an example of techniques which enable a UE 115-c to perform a tuning procedure of a machine learning model. For example, the UE 115-c may perform an online autonomous tuning procedure, and the network entity 105-b may refrain from performing the tuning procedure. The UE 115-c and the network entity 105-c may use one or more of RRC signaling, MAC-CE signaling, or physical layer signaling (e.g., a DCI) to communicate any of the signals or messages described in FIG. 4.

At 405, the UE 115-c may transmit a capability message to the network entity 105-c. The capability message may indicate whether the UE 115-c has the ability to tune (e.g., optimize or modify parameters of) an encoder (e.g., via tuning the encoder using the CSI samples collected by the UE 115-c) of the UE 115-c. The capability message may indicate whether the UE 115-c has the capability to perform offline tuning, online tuning, or both.

At 410, in some examples, the network entity 105-c may transmit an allowed status to the network entity 105-c. The allowed status may indicate to the UE 115-c that the UE 115-c is allowed to perform the autonomous online tuning procedure.

At 415, the UE 115-c may transmit an activation status or a deactivation status to the network entity 105-c. The activation status may indicate that the UE 115-c may start the online autonomous tuning of the encoder by determining updated parameters for the encoder (e.g., based on CSI data samples). The deactivation status may indicate that the UE 115-c may stop the online autonomous tuning of the encoder. The activation status or the deactivation status may result in a synchronization of the encoder (e.g., a state of the encoder) with the network entity 105-c.

At 420, the UE 115-c may start performing the online autonomous tuning procedure based on the activation status or deactivation status. The UE 115-c may perform the online autonomous tuning procedure if the UE 115-c determines a purpose for the procedure. The online tuning procedure may be associated with the UE 115-c tuning the encoder using the data samples obtained from the network entity 105-c. This may be obtained from the received reference signals from the network entity 105-c during an active communication session (e.g., on the fly). In this case, the UE 115-c may not use a separate instance of the decoder or the encoder to perform the tuning procedure. In some examples, the UE 115-c performing the autonomous online tuning procedure may interfere with the network entity 105-c. For example, the overall performance of the tuning procedure at the UE 115-c and the network entity 105-c may degrade as a result of the UE 115-c and the network entity 105-c separately tuning the encoder and the decoder. As such, the network entity 105-c may transmit signaling to the UE 115-c to control the tuning procedures.

At 425, the network entity 105-c transmit a disallowed status to the UE 115-c. The disallowed status may indicate for the UE 115-c to stop the autonomous tuning procedure.

At 430, the UE 115-c may stop performing the online tuning procedure based on the received deactivation status.

FIG. 5 illustrates an example of a process flow 500 that supports model tuning for cross node machine learning in accordance with one or more aspects of the present disclosure. In some examples, the process flow 500 may implement aspects of wireless communications system 100 and wireless communications system 200. The process flow 500 may include a UE 115-d and a network entity 105-d, which may be examples of a UE 115 and a network entity 105 as described herein with reference to FIGS. 1 and 2.

The process flow 500 may illustrate an example of techniques which enable a UE 115-d to perform a tuning procedure of a machine learning model. For example, the UE 115-d may perform an offline tuning procedure, and the network entity 105-d may refrain from performing the tuning procedure. The UE 115-d and the network entity 105-d may use one or more of RRC signaling, MAC-CE signaling, or physical layer signaling (e.g., a DCI) to communicate any of the signals or messages described in FIG. 5.

At 505, the UE 115-d may transmit a capability message to the network entity 105-d. The capability message may indicate whether the UE 115-d has the ability to tune the encoder. For example, the UE 115-d may be associated (e.g., undergo) a certain distribution of wireless channel data samples, and the UE 115-d may tune the encoder using the UE-specific CSI data sample distribution. The capability message may indicate whether the UE 115-d has the capability to perform offline tuning, online tuning, or both.

At 510, the UE 115-d may start performing the offline tuning procedure. The UE 115-d may perform the offline tuning procedure if the UE 115-d determines a need for the procedure. The offline tuning procedure may be associated with the UE 115-d tuning a separate instance of a first encoder, or a first encoder and decoder pair, and the UE 115-d may refrain from tuning a second encoder, or a second encoder and decoder pair at the UE 115-d.

At 515, the UE 115-d may transmit an indication to the network entity 105-d. The indication may indicate that the UE 115-d has an available encoder from the offline tuning procedure e.g., a fine-tuned encoder.

At 520, the network entity 105-d may transmit an activation status to the UE 115-d. In some examples, the network entity 105-d may transmit the activation status in response to the activation request. The activation status may indicate for the UE 115-d to be allowed to use the fine-tuned encoder. The UE 115-d may explicitly accept or reject the activation status. In some examples, the activation status may request for the UE 115-d to use the baseline machine learning model for the encoder.

At 525, the UE 115-d may start using the fine-tuned encoder based on the activation status.

At 530, in some examples, the UE 115-d may transmit a deactivation status to the network entity 105-d. The deactivation status may indicate that the UE 115-d is stopping to use the fine-tuned encoder and starting to use the baseline machine learning model for the encoder.

At 535, in some examples, the UE 115-d may stop using the offline fine-tuned encoder based on the transmitted deactivation status. Deactivation may be initiated by the UE 115-d or the network entity 105-d.

At 540, the network entity 105-d may transmit a deactivation status to the UE 115-d. The deactivation status may indicate to the UE 115-d to stop using the offline fine-tuned encoder.

At 545, the UE 115-d may stop using the offline fine-tuned encoder based on the received deactivation status.

FIG. 6 illustrates an example of a process flow 600 that supports model tuning for cross node machine learning in accordance with one or more aspects of the present disclosure. In some examples, the process flow 600 may implement aspects of wireless communications system 100 and wireless communications system 200. The process flow 600 may include a UE 115-e and a network entity 105-e, which may be examples of a UE 115 and a network entity 105 as described herein with reference to FIGS. 1 and 2.

The process flow 600 may illustrate an example of techniques which enable a UE 115-e to perform a tuning procedure of a machine learning model. For example, the UE 115-e may perform an offline autonomous tuning procedure, and the network entity 105-e may refrain from performing the tuning procedure. The UE 115-e and the network entity 105-e may use one or more of RRC signaling, MAC-CE signaling, or physical layer signaling (e.g., a DCI) to communicate any of the signals or messages described in FIG. 6.

At 605, the UE 115-e may transmit a capability message to the network entity 105-e. The capability message may indicate whether the UE 115-e has the ability to tune (e.g., optimize) the encoder (e.g., via tuning the encoder using the CSI samples collected by the UE 115-e). The capability message may indicate whether the UE 115-e has the capability to perform offline tuning, online tuning, or both.

At 610, the UE 115-e may start performing the offline autonomous tuning procedure. The UE 115-e may perform the offline autonomous tuning procedure if the UE 115-d determines a need for the procedure. The offline autonomous tuning procedure may be associated with the UE 115-e tuning a separate instance of a first encoder, or a first encoder and decoder pair, and the UE 115-e may refrain from tuning a second encoder or a second encoder and decoder pair at the UE 115-e.

At 615, in some examples, the UE 115-e may transmit an indication to the network entity 105-e. The indication may indicate that the UE 115-e has an available encoder from the offline tuning procedure i.e., a fine-tuned encoder.

At 620, in some examples, the network entity 105-e may transmit an allowed status to the network entity 105-e. The allowed status may indicate to the UE 115-e that the UE 115-e is allowed to use the fine-tuned encoder.

At 625, in some examples, the UE 115-e may transmit an activation status or a deactivation status to the network entity 105-e. The activation status may indicate that the UE 115-e may start using the fine-tuned encoder. The deactivation status may indicate that the UE 115-e may stop using the fine-tuned encoder. The activation status or the deactivation status may result in a synchronization of the encoder (e.g., a state of the encoder) with the network entity 105-e.

At 630, the UE 115-c may start using the offline fine-tuned encoder. This may be based on the activation status or deactivation status. In some examples, the UE 115-e performing the offline autonomous tuning procedure may interfere with the network entity 105-e. For example, the overall performance of the tuning procedure at the UE 115-e and the network entity 105-e may degrade as a result of the UE 115-e and the network entity 105-e separately tuning the encoder and the decoder. As such, the network entity 105-e may transmit signaling to the UE 115-c to control the tuning procedures.

At 635, the network entity 105-e transmit a disallowed status to the UE 115-e. The disallowed status may indicate for the UE 115-e to stop using the fine-tuned encoder.

At 640, the UE 115-e may stop using the fine-tuned encoder based on the received deactivation status.

FIG. 7 illustrates an example of a process flow 700 that supports model tuning for cross node machine learning in accordance with one or more aspects of the present disclosure. In some examples, the process flow 700 may implement aspects of wireless communications system 100 and wireless communications system 200. The process flow 700 may include a UE 115-f and a network entity 105-f, which may be examples of a UE 115 and a network entity 105 as described herein with reference to FIGS. 1 and 2. The process flow 700 may illustrate an example of techniques which enable a UE 115-f to perform a tuning procedure of a machine learning model. For example, the UE 115-f may perform the tuning procedure, and the UE 115-f may not have information regarding the decoder of the network entity 105-f. The UE 115-f may have information regarding the encoder, and the information may be communicated by the network entity 105-f or configured by the network entity 105-f.

In some examples, since the UE 115-f may not have information regarding the decoder, the tuning procedure may include forward propagation and back propagation. Forward propagation may include a method to move an input layer, such as the first data set, to an output layer, such as the decoded channel state. Back propagation may include a method to move the output layer to the input layer (e.g., decoded channel state to the first data set). In this example, the UE 115-f may provide the information associated with the forward propagation to the network entity 105-f. For example, the UE 115-f may transmit parameters v and z to the network entity 105. The network entity 105-f may respond with information associated with the back propagation to the UE 115-f. The network entity 105-f may transmit a gradient of the loss function derived from the decoded channel state (∇_{z}L, where L corresponds to the loss function defined by Equation 3). In some examples, the UE 115-f may tune (e.g., update) the encoder based on the gradient. The UE 115-f may tune the encoder θ until a stop criteria occurs. The stop criteria may include a convergence of the gradient of the loss function, a limit of the number of tuning steps, or signaling for the UE 115-f to stop the tuning procedure. In some examples, the UE 115-f may perform the tuning procedure opportunistically. For example, to reduce signaling overhead from forward propagation and back propagation, the UE 115-f may perform the tuning procedure when the network entity 105-f is under-utilized (e.g., the UE 115-f may receive an allowed status), which may be described in more detail below.

At 705, in some examples, the network entity 105-f may transmit loss function information (e.g., a) to the UE 115-f for the UE 115-f for back propagation. The UE 115-f may use the loss function information as a one-time input for the gradient of the loss function.

At 710, the UE 115-f may transmit parameters v and z to the network entity 105-f for forward propagation.

At 715, the network entity 105-f may use the parameters to perform forward propagation and to derive \hat{v}, the decoded channel state at the decoder. The network entity 105-f may perform a computation of the loss function L using the received parameters v and z and the derived parameter \hat{v}.

At 720, the network entity 105-f may use the loss function L and parameter v to perform gradient back propagation of the decoder.

At 725, the network entity 105-f may transmit parameters v and L for back propagation at the UE 115-f.

At 730, the UE 115-f may use the parameters to perform gradient back propagation of the encoder.

At 735, based on the gradient back propagation, the UE 115-f may update (e.g., tune) the encoder θ until a stop criteria occurs. For example, the tuning of the encoder may be defined by Equation 5:

$${θ}_{n + 1} = {θ}_{n} + μ \frac{\partial L}{\partial θ} \qquad ( 5 )$$

where a partial derivative may be evaluated at θ=θₙ, n corresponds to a number of tuning steps,

$$\frac{\partial L}{\partial θ}$$

corresponds to the partial derivative of the loss function, μ and corresponds to a step size. The number of tuning steps may be equal to or greater than one for a given v.

FIG. 8 illustrates an example of a process flow 800 that supports model tuning for cross node machine learning in accordance with one or more aspects of the present disclosure. The process flow 800 may include a UE 115-g and a network entity 105-g, which may be examples of a UE 115 and a network entity 105 as described herein with reference to FIGS. 1 and 2. The process flow 800 may illustrate an example of techniques which enable a UE 115-g to perform a tuning procedure of a machine learning model. For example, the UE 115-g and the network entity 105-g may jointly perform the online tuning procedure of both the encoder and the decoder.

Performing the online tuning procedure jointly may include forward propagation and back propagation. In this example, the UE 115-g may provide the information associated with the forward propagation to the network entity 105-g. For example, the UE 115-g may transmit parameters v and z to the network entity 105-g. The network entity 105-g may use the parameters to calculate the gradient of the loss function derived from the decoded channel state (∇_{z}L), and the network entity 105-g may update the decoder parameters φ based on the gradient. In some examples, the network entity 105-g may transmit information associated with the back propagation to the UE 115-g.

For example, the network entity 105-g may transmit parameters associated with gradient of the loss function. In some examples, the UE 115-g may calculate the gradient and tune the encoder based on the gradient. The UE 115-g may tune the encoder θ until a stop criteria occurs. The stop criteria may include a convergence of the gradient of the loss function, a limit of the number of tuning steps, or signaling for the UE 115-g to stop the tuning procedure. In this example, the network entity 105-g may not have information related to the encoder at the UE 115-g, but the encoder θ and the decoder φ may be jointly tuned. In some examples, the UE 115-g may perform the tuning procedure opportunistically. For example, to reduce signaling overhead from forward propagation and back propagation, the UE 115-g may perform the tuning procedure when the network entity 105-g is under-utilized (e.g., the UE 115-g may receive an allowed status), which may be described in more detail below.

At 805, the network entity 105-f may transmit loss function information (e.g., a) to the UE 115-g for the UE 115-g for back propagation. The UE 115-g may use the loss function information as a one-time input for the gradient of the loss function.

At 810, the UE 115-g may transmit parameters v and z to the network entity 105-g for forward propagation.

At 815, the network entity 105-g may use the parameters to perform forward propagation and to derive \hat{v}, the decoded channel state at the decoder. The network entity 105-g may perform a computation of the loss function L using the received parameters v and z and the derived parameter \hat{v}.

At 820, the network entity 105-f may use the loss function L and parameter v to perform gradient back propagation of the decoder.

At 825, based on the gradient back propagation, the network entity 105-g may update (e.g., tune) the decoder φ until a stop criteria occurs. For example, the tuning of the decoder may be defined by Equation 6:

$${φ}_{n + 1} = {φ}_{n} + ϵ \frac{\partial L}{\partial φ} \qquad ( 6 )$$

where a partial derivative may be evaluated at φ=φₙ, n corresponds to a number of tuning steps,

$$\frac{\partial L}{\partial φ}$$

corresponds to the partial derivative of the loss function, and ϵ corresponds to a step size. The number of tuning steps may be equal to or greater than one for a given v.

At 830, the network entity 105-g may transmit parameters v and L for back propagation at the UE 115-g.

At 835, the UE 115-g may use the parameters to perform gradient back propagation of the encoder.

At 840, based on the gradient back propagation, the UE 115-f may update (e.g., tune) the encoder θ until a stop criteria occurs, as defined by Equation 5.

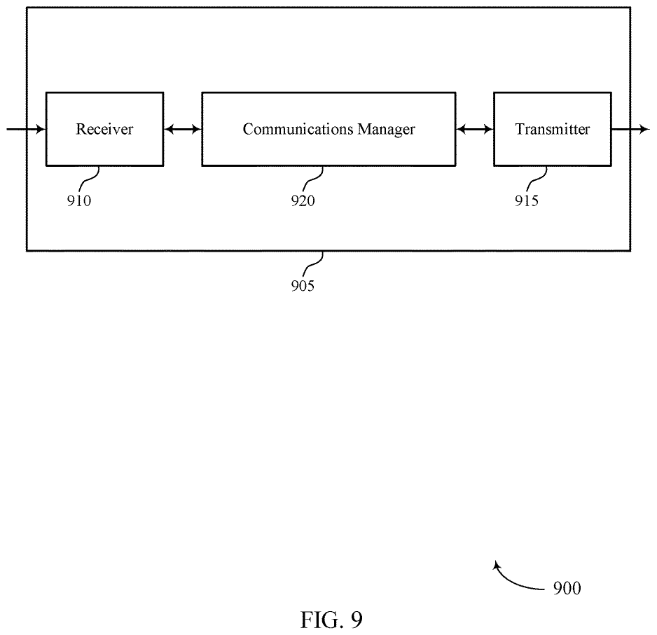

FIG. 9 illustrates a block diagram 900 of a device 905 that supports model tuning for cross node machine learning in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to model tuning for cross node machine learning). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to model tuning for cross node machine learning). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of model tuning for cross node machine learning as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. For example, the communications manager 920 may be configured as or otherwise support a means for obtaining data samples for a first machine learning model associated with a task at the UE, where a first set of parameters is associated with the first machine learning model. The communications manager 920 may be configured as or otherwise support a means for transmitting a capability message indicating a capability of the UE to perform a tuning procedure of the first machine learning model. The communications manager 920 may be configured as or otherwise support a means for performing the tuning procedure of the first machine learning model to obtain a second set of parameters associated with the first machine learning model based on the capability of the UE to perform the tuning procedure of the first machine learning model. The communications manager 920 may be configured as or otherwise support a means for transmitting, to a network entity, a message indicating at least a portion of the second set of parameters based on performing the tuning procedure of the first machine learning model.

Additionally, or alternatively, the communications manager 920 may support wireless communication at a UE with a first set of parameters associated with a first machine learning model for a task in accordance with examples as disclosed herein. For example, the communications manager 920 may be configured as or otherwise support a means for transmitting, to a network entity, a capability message indicating a capability of the UE to perform a tuning procedure of a first machine learning model, where a first set of parameters is associated with the first machine learning model. The communications manager 920 may be configured as or otherwise support a means for performing the tuning procedure of the first machine learning model to obtain a second set of parameters associated with the first machine learning model based on the capability of the UE to perform the tuning procedure of the first machine learning model. The communications manager 920 may be configured as or otherwise support a means for transmitting, to a network entity, a message indicating the second set of parameters based on performing the tuning procedure of the first machine learning model. The communications manager 920 may be configured as or otherwise support a means for receiving an allowed status indication from the network entity associated with the second set of parameters. The communications manager 920 may be configured as or otherwise support a means for performing the task using the first set of parameters associated with the first machine learning model or the second set of parameters associated with the first machine learning model based on the received allowed status indication. The communications manager 920 may be configured as or otherwise support a means for receiving a disallowed status indication from the network entity associated with the second set of parameters. The communications manager 920 may be configured as or otherwise support a means for performing the task using the first set of parameters associates with the first machine learning model based on the received disallowed status indication.

Additionally, or alternatively, the communications manager 920 may support wireless communication at a UE with a first set of parameters associated with a first machine learning model for a task in accordance with examples as disclosed herein. For example, the communications manager 920 may be configured as or otherwise support a means for transmitting, to a network entity, a capability message indicating a capability of the UE to perform an online tuning procedure of the first machine learning model, where a first set of parameters is associated with the first machine learning model. The communications manager 920 may be configured as or otherwise support a means for receiving a first indication from the network entity associated with the online tuning procedure, where the first indication includes an activation status, or an allowed status. The communications manager 920 may be configured as or otherwise support a means for performing the online tuning procedure of the first machine learning model to obtain a second set of parameters associated with the first machine learning model based on the capability of the UE to perform the tuning procedure of the first machine learning model and the received allowed status.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption and more efficient utilization of communication resources. For example, by transmitting a capability message to a network entity, the UE may inform the network entity of the capability of autonomous tuning of the second machine learning model. Autonomously performing the tuning procedure may result in the processor for the device 905 more efficiently tuning the second machine learning model and reducing latency in communications using the second machine learning model.

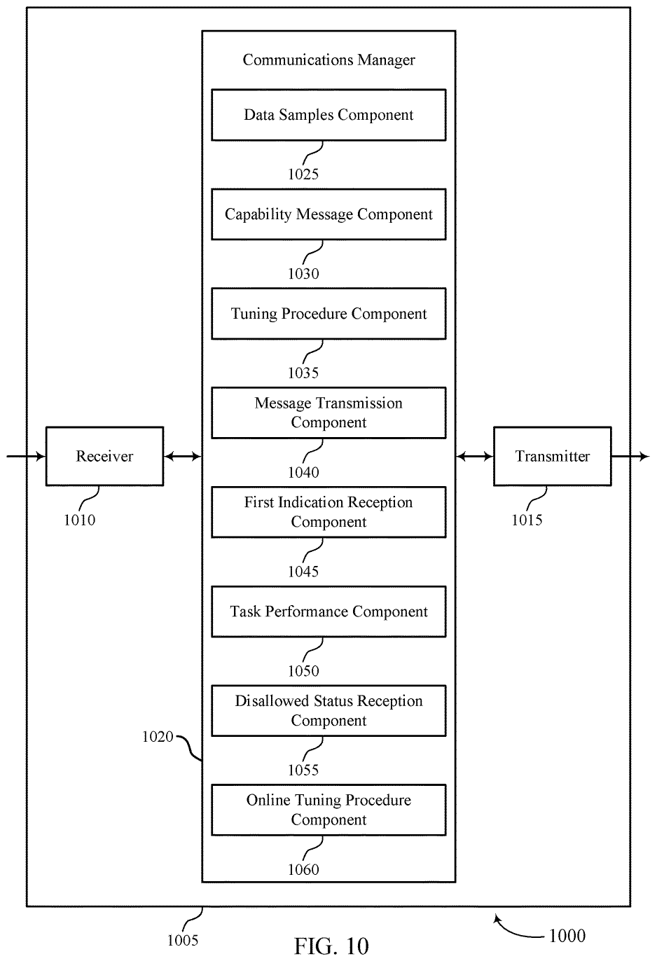

FIG. 10 illustrates a block diagram 1000 of a device 1005 that supports model tuning for cross node machine learning in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to model tuning for cross node machine learning). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to model tuning for cross node machine learning). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of model tuning for cross node machine learning as described herein. For example, the communications manager 1020 may include a data samples component 1025, a capability message component 1030, a tuning procedure component 1035, a message transmission component 1040, a first indication reception component 1045, a task performance component 1050, a disallowed status reception component 1055, an online tuning procedure component 1060, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The data samples component 1025 may be configured as or otherwise support a means for obtaining data samples for a first machine learning model associated with a task at the UE, where a first set of parameters is associated with the first machine learning model. The capability message component 1030 may be configured as or otherwise support a means for transmitting a capability message indicating a capability of the UE to perform a tuning procedure of the first machine learning model. The tuning procedure component 1035 may be configured as or otherwise support a means for performing the tuning procedure of the first machine learning model to obtain a second set of parameters associated with the first machine learning model based on the capability of the UE to perform the tuning procedure of the first machine learning model. The message transmission component 1040 may be configured as or otherwise support a means for transmitting, to a network entity, a message indicating at least a portion of the second set of parameters based on performing the tuning procedure of the first machine learning model.

Additionally, or alternatively, the communications manager 1020 may support wireless communication at a UE with a first set of parameters associated with a first machine learning model for a task in accordance with examples as disclosed herein. The capability message component 1030 may be configured as or otherwise support a means for transmitting, to a network entity, a capability message indicating a capability of the UE to perform a tuning procedure of a first machine learning model, where a first set of parameters is associated with the first machine learning model. The tuning procedure component 1035 may be configured as or otherwise support a means for performing the tuning procedure of the first machine learning model to obtain a second set of parameters associated with the first machine learning model based on the capability of the UE to perform the tuning procedure of the first machine learning model. The message transmission component 1040 may be configured as or otherwise support a means for transmitting, to a network entity, a message indicating the second set of parameters based on performing the tuning procedure of the first machine learning model. The first indication reception component 1045 may be configured as or otherwise support a means for receiving an allowed status indication from the network entity associated with the second set of parameters. The task performance component 1050 may be configured as or otherwise support a means for performing the task using the first set of parameters associated with the first machine learning model or the second set of parameters associated with the first machine learning model based on the received allowed status indication. The disallowed status reception component 1055 may be configured as or otherwise support a means for receiving a disallowed status indication from the network entity associated with the second set of parameters. The task performance component 1050 may be configured as or otherwise support a means for performing the task using the first set of parameters associates with the first machine learning model based on the received disallowed status indication.

The task performance component 1050 may be configured as or otherwise support a means for autonomously determining whether to perform the task using the first set of parameters associated with the first machine learning model or using the second set of parameters associated with the first machine learning model based at least in part on the received allowed status indication.

Additionally, or alternatively, the communications manager 1020 may support wireless communication at a UE with a first set of parameters associated with a first machine learning model for a task in accordance with examples as disclosed herein. The capability message component 1030 may be configured as or otherwise support a means for transmitting, to a network entity, a capability message indicating a capability of the UE to perform an online tuning procedure of the first machine learning model, where a first set of parameters is associated with the first machine learning model. The first indication reception component 1045 may be configured as or otherwise support a means for receiving a first indication from the network entity associated with the online tuning procedure, where the first indication includes an activation status, or an allowed status. The online tuning procedure component 1060 may be configured as or otherwise support a means for performing the online tuning procedure of the first machine learning model to obtain a second set of parameters associated with the first machine learning model based on the capability of the UE to perform the tuning procedure of the first machine learning model and the received allowed status.

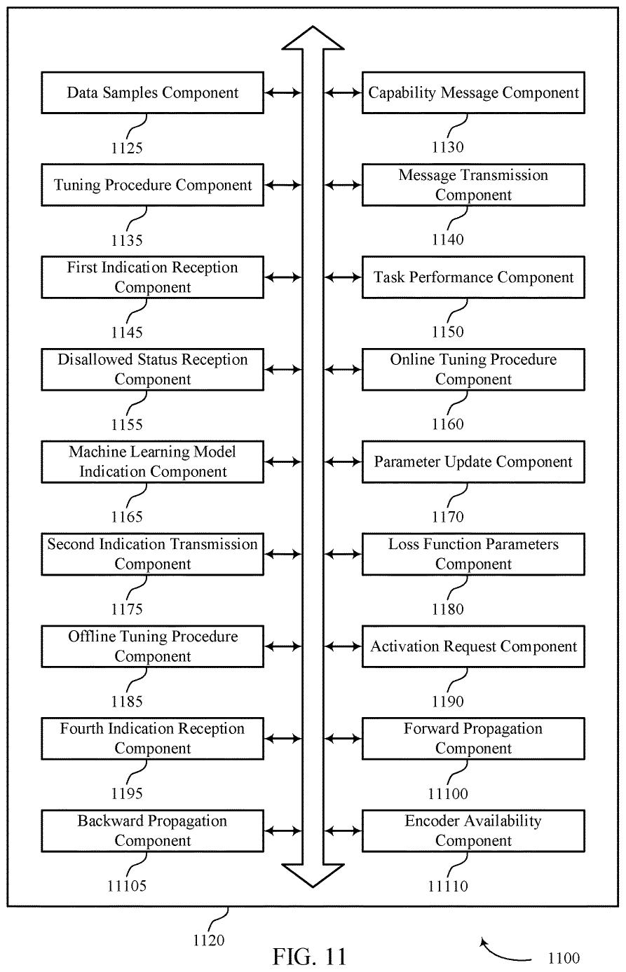

FIG. 11 illustrates a block diagram 1100 of a communications manager 1120 that supports model tuning for cross node machine learning in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of model tuning for cross node machine learning as described herein. For example, the communications manager 1120 may include a data samples component 1125, a capability message component 1130, a tuning procedure component 1135, a message transmission component 1140, a first indication reception component 1145, a task performance component 1150, a disallowed status reception component 1155, an online tuning procedure component 1160, a machine learning model indication component 1165, a parameter update component 1170, a second indication transmission component 1175, a loss function parameters component 1180, an offline tuning procedure component 1185, an activation request component 1190, a fourth indication reception component 1195, a forward propagation component 11100, a backward propagation component 11105, an encoder availability component 11110, or any combination thereof. Each of these components may communicate, directly or indirectly, with one another (e.g., via one or more buses).

The communications manager 1120 may support wireless communication at a UE in accordance with examples as disclosed herein. The data samples component 1125 may be configured as or otherwise support a means for obtaining data samples for a first machine learning model associated with a task at the UE, where a first set of parameters is associated with the first machine learning model. The capability message component 1130 may be configured as or otherwise support a means for transmitting a capability message indicating a capability of the UE to perform a tuning procedure of the first machine learning model. The tuning procedure component 1135 may be configured as or otherwise support a means for performing the tuning procedure of the first machine learning model to obtain a second set of parameters associated with the first machine learning model based on the capability of the UE to perform the tuning procedure of the first machine learning model. The message transmission component 1140 may be configured as or otherwise support a means for transmitting, to a network entity, a message indicating at least a portion of the second set of parameters based on performing the tuning procedure of the first machine learning model.

In some examples, the first machine learning model includes an encoder portion of a second machine learning model. In some examples, a third machine learning model includes a decoder portion of the second machine learning model.

In some examples, to support performing the tuning procedure of the first machine learning model, the loss function parameters component 1180 may be configured as or otherwise support a means for receiving a set of parameters associated with a loss function.

In some examples, the forward propagation component 11100 may be configured as or otherwise support a means for transmitting a message associated with a forward propagation procedure.

In some examples, the backward propagation component 11105 may be configured as or otherwise support a means for receiving a message associated with a backward propagation procedure for adjusting parameters associated with an encoder, where the message indicates a gradient associated with the loss function. In some examples, the parameter update component 1170 may be configured as or otherwise support a means for updating the parameters associated with the encoder based on the message.

In some examples, the loss function parameters component 1180 may be configured as or otherwise support a means for receiving the set of parameters associated with the loss function. In some examples, the parameter update component 1170 may be configured as or otherwise support a means for updating parameters associated with the decoder portion of the second machine learning model based on the set of parameters.

In some examples, to support transmitting the capability message, the machine learning model indication component 1165 may be configured as or otherwise support a means for transmitting an indication of a set of machine learning models supported by the UE.

In some examples, the task includes a Channel State Information (CSI) feedback task.

In some examples, to support performing the tuning procedure of the first machine learning model, the parameter update component 1170 may be configured as or otherwise support a means for updating parameters associated with an encoder, parameters associated with a decoder, or both using the second set of parameters.

In some examples, to support performing the tuning procedure of the first machine learning model, the online tuning procedure component 1160 may be configured as or otherwise support a means for performing an online tuning procedure.

In some examples, to support performing the online tuning procedure of the first machine learning model, the parameter update component 1170 may be configured as or otherwise support a means for updating the second set of parameters associated with the encoder using the second set of parameters for the first machine learning model in performing the task.

In some examples, to support performing the tuning procedure of the first machine learning model, the offline tuning procedure component 1185 may be configured as or otherwise support a means for performing an offline tuning procedure.

In some examples, to support performing the offline tuning procedure of the first machine learning model, the parameter update component 1170 may be configured as or otherwise support a means for updating the second set of parameters associated with the encoder using the first set of parameters for the first machine learning model in performing the task.

In some examples, the encoder availability component 11110 may be configured as or otherwise support a means for transmitting a third indication to the network entity, where the third indication indicates an availability of a second encoder, where the second encoder is associated with performing the offline tuning procedure.

In some examples, to support performing the tuning procedure, the first indication reception component 1145 may be configured as or otherwise support a means for receiving a first indication from the network entity associated with performing the tuning procedure of the first machine learning model, where the first indication includes an activation status or an allowed status. In some examples, to support performing the tuning procedure, the second indication transmission component 1175 may be configured as or otherwise support a means for transmitting a second indication to the network entity in response to the first indication, where the second indication includes an activation indication associated with starting to perform the tuning procedure or a deactivation indication associated with stopping the tuning procedure.

In some examples, the activation request component 1190 may be configured as or otherwise support a means for transmitting an activation request to the network entity, where receiving the first indication is based on the activation request.

In some examples, the fourth indication reception component 1195 may be configured as or otherwise support a means for receiving a fourth indication from the network entity, where the fourth indication includes a deactivation indication associated with stopping the tuning procedure.

In some examples, to support performing the tuning procedure of the first machine learning model, the parameter update component 1170 may be configured as or otherwise support a means for updating parameters associated with an encoder, parameters associated with a decoder, or both using the second set of parameters based on a gradient associated with the first set of parameters and the second set of parameters.

In some examples, to support updating parameters associated with an encoder, parameters associated with a decoder, or both, the loss function parameters component 1180 may be configured as or otherwise support a means for receiving a set of parameters associated with a loss function. In some examples, to support updating parameters associated with an encoder, parameters associated with a decoder, or both, the forward propagation component 11100 may be configured as or otherwise support a means for transmitting a message associated with a forward propagation procedure.

In some examples, the backward propagation component 11105 may be configured as or otherwise support a means for receiving a message associated with a backward propagation procedure for adjusting parameters associated with an encoder, parameters associated with a decoder, or both, where the message indicates a gradient associated with the loss function. In some examples, the parameter update component 1170 may be configured as or otherwise support a means for updating the parameters associated with the encoder, parameters associated with a decoder, or both based on the message.

In some examples, the UE receives the indication of the first set of parameters via broadcast signaling, dedicated signaling, or both.

Additionally, or alternatively, the communications manager 1120 may support wireless communication at a UE with a first set of parameters associated with a first machine learning model for a task in accordance with examples as disclosed herein. In some examples, the capability message component 1130 may be configured as or otherwise support a means for transmitting, to a network entity, a capability message indicating a capability of the UE to perform a tuning procedure of a first machine learning model, where a first set of parameters is associated with the first machine learning model. In some examples, the tuning procedure component 1135 may be configured as or otherwise support a means for performing the tuning procedure of the first machine learning model to obtain a second set of parameters associated with the first machine learning model based on the capability of the UE to perform the tuning procedure of the first machine learning model. In some examples, the message transmission component 1140 may be configured as or otherwise support a means for transmitting, to a network entity, a message indicating the second set of parameters based on performing the tuning procedure of the first machine learning model. The first indication reception component 1145 may be configured as or otherwise support a means for receiving an allowed status indication from the network entity associated with the second set of parameters. The task performance component 1150 may be configured as or otherwise support a means for performing the task using the first set of parameters associated with the first machine learning model or the second set of parameters associated with the first machine learning model based on the received allowed status indication. The disallowed status reception component 1155 may be configured as or otherwise support a means for receiving a disallowed status indication from the network entity associated with the second set of parameters. In some examples, the task performance component 1150 may be configured as or otherwise support a means for performing the task using the first set of parameters associates with the first machine learning model based on the received disallowed status indication.

Additionally, or alternatively, the communications manager 1120 may support wireless communication at a UE with a first set of parameters associated with a first machine learning model for a task in accordance with examples as disclosed herein. In some examples, the capability message component 1130 may be configured as or otherwise support a means for transmitting, to a network entity, a capability message indicating a capability of the UE to perform an online tuning procedure of the first machine learning model, where a first set of parameters is associated with the first machine learning model. In some examples, the first indication reception component 1145 may be configured as or otherwise support a means for receiving a first indication from the network entity associated with the online tuning procedure, where the first indication includes an activation status, or an allowed status. The online tuning procedure component 1160 may be configured as or otherwise support a means for performing the online tuning procedure of the first machine learning model to obtain a second set of parameters associated with the first machine learning model based on the capability of the UE to perform the tuning procedure of the first machine learning model and the received allowed status.

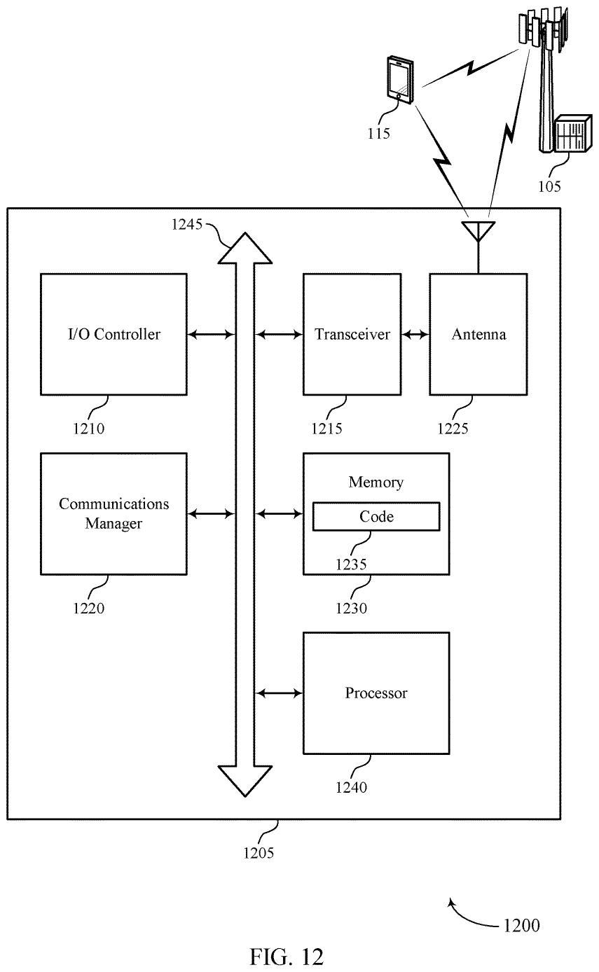

FIG. 12 illustrates a diagram of a system 1200 including a device 1205 that supports model tuning for cross node machine learning in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting model tuning for cross node machine learning). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for obtaining data samples for a first machine learning model associated with a task at the UE, where a first set of parameters is associated with the first machine learning model. The communications manager 1220 may be configured as or otherwise support a means for transmitting a capability message indicating a capability of the UE to perform a tuning procedure of the first machine learning model. The communications manager 1220 may be configured as or otherwise support a means for performing the tuning procedure of the first machine learning model to obtain a second set of parameters associated with the first machine learning model based on the capability of the UE to perform the tuning procedure of the first machine learning model. The communications manager 1220 may be configured as or otherwise support a means for transmitting, to a network entity, a message indicating at least a portion of the second set of parameters based on performing the tuning procedure of the first machine learning model.

Additionally, or alternatively, the communications manager 1220 may support wireless communication at a UE with a first set of parameters associated with a first machine learning model for a task in accordance with examples as disclosed herein. For example, the communications manager 1220 may be configured as or otherwise support a means for transmitting, to a network entity, a capability message indicating a capability of the UE to perform a tuning procedure of a first machine learning model, where a first set of parameters is associated with the first machine learning model. The communications manager 1220 may be configured as or otherwise support a means for performing the tuning procedure of the first machine learning model to obtain a second set of parameters associated with the first machine learning model based on the capability of the UE to perform the tuning procedure of the first machine learning model. The communications manager 1220 may be configured as or otherwise support a means for transmitting, to a network entity, a message indicating the second set of parameters based on performing the tuning procedure of the first machine learning model. The communications manager 1220 may be configured as or otherwise support a means for receiving an allowed status indication from the network entity associated with the second set of parameters. The communications manager 1220 may be configured as or otherwise support a means for performing the task using the first set of parameters associated with the first machine learning model or the second set of parameters associated with the first machine learning model based on the received allowed status indication. The communications manager 1220 may be configured as or otherwise support a means for receiving a disallowed status indication from the network entity associated with the second set of parameters. The communications manager 1220 may be configured as or otherwise support a means for performing the task using the first set of parameters associates with the first machine learning model based on the received disallowed status indication.

Additionally, or alternatively, the communications manager 1220 may support wireless communication at a UE with a first set of parameters associated with a first machine learning model for a task in accordance with examples as disclosed herein. For example, the communications manager 1220 may be configured as or otherwise support a means for transmitting, to a network entity, a capability message indicating a capability of the UE to perform an online tuning procedure of the first machine learning model, where a first set of parameters is associated with the first machine learning model. The communications manager 1220 may be configured as or otherwise support a means for receiving a first indication from the network entity associated with the online tuning procedure, where the first indication includes an activation status, or an allowed status. The communications manager 1220 may be configured as or otherwise support a means for performing the online tuning procedure of the first machine learning model to obtain a second set of parameters associated with the first machine learning model based on the capability of the UE to perform the tuning procedure of the first machine learning model and the received allowed status.

By including or configuring the communications manager 1220 in accordance with examples as described herein, the device 1205 may support techniques for reduced latency and more efficient utilization of communication resources. For example, by transmitting a capability message to a network entity, the UE may inform the network entity of the capability of autonomous tuning of the second machine learning model. Autonomously performing the tuning procedure may result in the processor for the device 1205 more efficiently tuning the second machine learning model and reducing latency in communications using the second machine learning model.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of model tuning for cross node machine learning as described herein, or the processor 1240 and the memory 1230 may be otherwise configured to perform or support such operations.

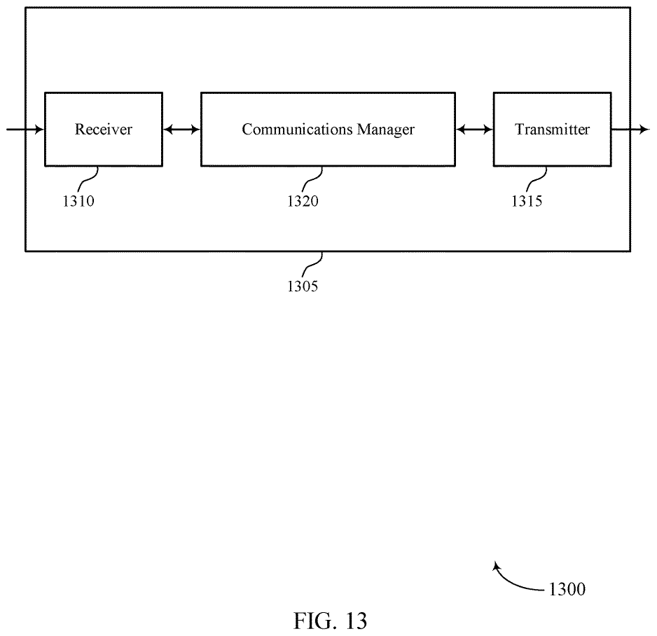

FIG. 13 illustrates a block diagram 1300 of a device 1305 that supports model tuning for cross node machine learning in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of model tuning for cross node machine learning as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. For example, the communications manager 1320 may be configured as or otherwise support a means for receiving, from a UE, a capability message indicating a capability of the UE to perform a tuning procedure of a first machine learning model associated with a first set of parameters at the UE. The communications manager 1320 may be configured as or otherwise support a means for receiving, from the UE, a message indicating at least a portion of a second set of parameters.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced power consumption and more efficient utilization of communication resources. For example, by transmitting a capability message to a network entity, the UE may inform the network entity of the capability of autonomous tuning of the second machine learning model. Autonomously performing the tuning procedure may result in the processor for the device 1305 more efficiently tuning the second machine learning model and reducing latency in communications using the second machine learning model.

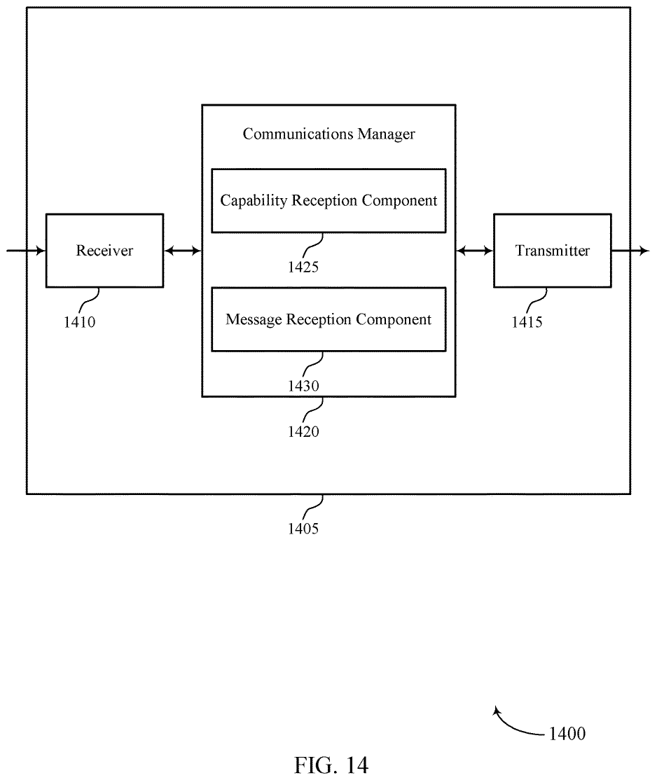

FIG. 14 illustrates a block diagram 1400 of a device 1405 that supports model tuning for cross node machine learning in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of model tuning for cross node machine learning as described herein. For example, the communications manager 1420 may include a capability reception component 1425 a message reception component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. The capability reception component 1425 may be configured as or otherwise support a means for receiving, from a UE, a capability message indicating a capability of the UE to perform a tuning procedure of a first machine learning model associated with a first set of parameters at the UE. The message reception component 1430 may be configured as or otherwise support a means for receiving, from the UE, a message indicating at least a portion of a second set of parameters.

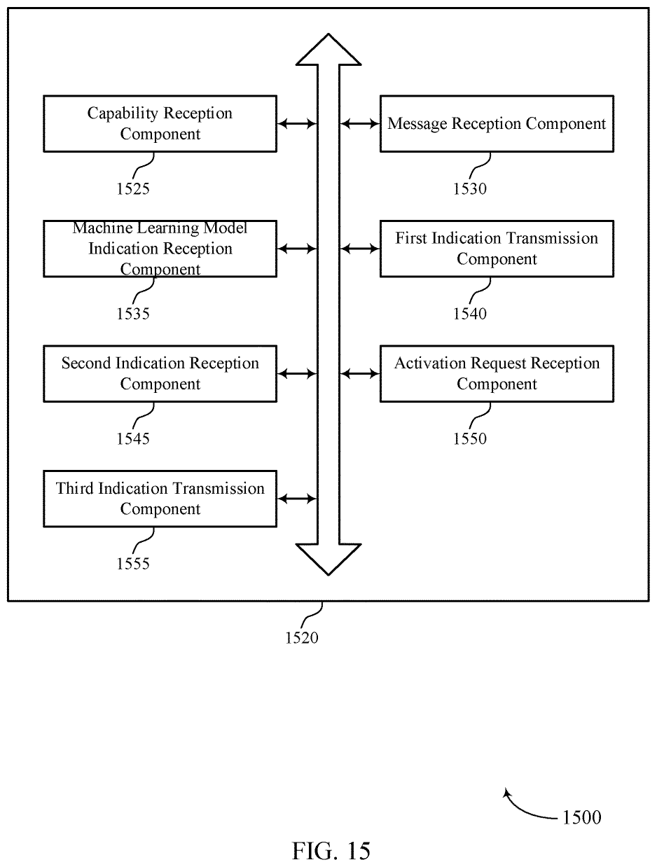

FIG. 15 illustrates a block diagram 1500 of a communications manager 1520 that supports model tuning for cross node machine learning in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of model tuning for cross node machine learning as described herein. For example, the communications manager 1520 may include a capability reception component 1525, a message reception component 1530, a machine learning model indication reception component 1535, a first indication transmission component 1540, a second indication reception component 1545, an activation request reception component 1550, a third indication transmission component 1555, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The capability reception component 1525 may be configured as or otherwise support a means for receiving, from a UE, a capability message indicating a capability of the UE to perform a tuning procedure of a first machine learning model associated with a first set of parameters at the UE. The message reception component 1530 may be configured as or otherwise support a means for receiving, from the UE, a message indicating at least a portion of a second set of parameters.

In some examples, the first machine learning model includes an encoder portion of a second machine learning model. In some examples, a third machine learning model includes a decoder portion of the second machine learning model.

In some examples, to support receiving the capability message, the machine learning model indication reception component 1535 may be configured as or otherwise support a means for receiving an indication of a set of machine learning models supported by the UE.

In some examples, receiving the message is associated with receiving channel state information feedback.

In some examples, the first indication transmission component 1540 may be configured as or otherwise support a means for transmitting, to the UE, a first indication associated with performing a tuning procedure of the first machine learning model, where the first indication includes an activation status or an allowed status. In some examples, the second indication reception component 1545 may be configured as or otherwise support a means for receiving, from the UE, a second indication in response to the first indication, where the second indication includes an activation indication associated with starting to perform the tuning procedure or a deactivation indication associated with stopping the tuning procedure.

In some examples, the activation request reception component 1550 may be configured as or otherwise support a means for receiving, from the UE, an activation request, where transmitting the first indication is based on the activation request.

In some examples, the third indication transmission component 1555 may be configured as or otherwise support a means for transmitting, to the UE, a third indication, where the third indication includes a deactivation indication associated with stopping the tuning procedure.

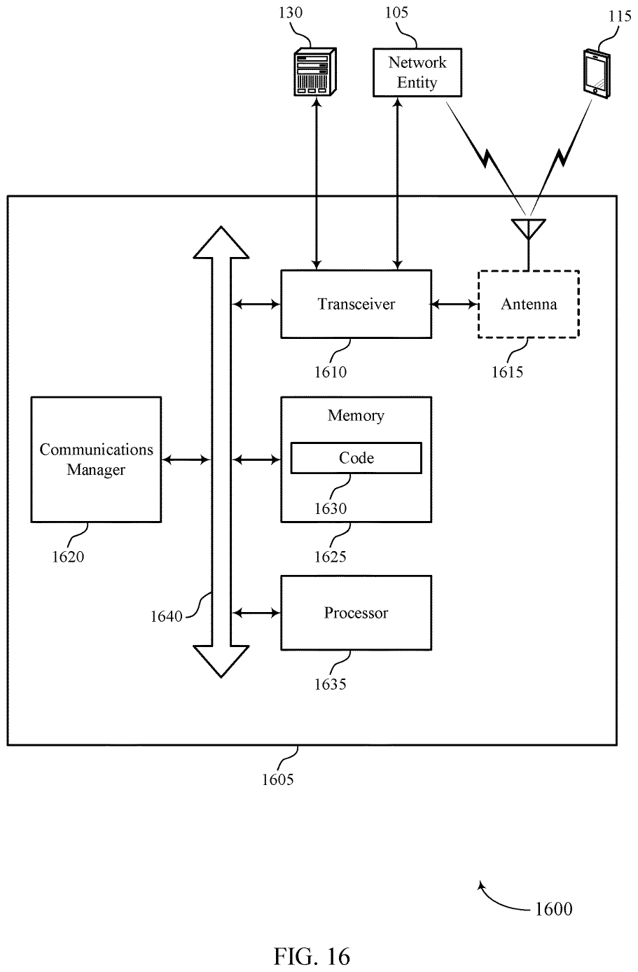

FIG. 16 illustrates a diagram of a system 1600 including a device 1605 that supports model tuning for cross node machine learning in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting model tuning for cross node machine learning). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity in accordance with examples as disclosed herein. For example, the communications manager 1620 may be configured as or otherwise support a means for receiving, from a UE, a capability message indicating a capability of the UE to perform a tuning procedure of a first machine learning model associated with a first set of parameters at the UE. The communications manager 1620 may be configured as or otherwise support a means for receiving, from the UE, a message indicating at least a portion of a second set of parameters.

By including or configuring the communications manager 1620 in accordance with examples as described herein, the device 1605 may support techniques for reduced latency and more efficient utilization of communication resources. For example, by transmitting a capability message to a network entity, the UE may inform the network entity of the capability of autonomous tuning of the second machine learning model. Autonomously performing the tuning procedure may result in the processor for the device 1605 more efficiently tuning the second machine learning model and reducing latency in communications using the second machine learning model.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of model tuning for cross node machine learning as described herein, or the processor 1635 and the memory 1625 may be otherwise configured to perform or support such operations.

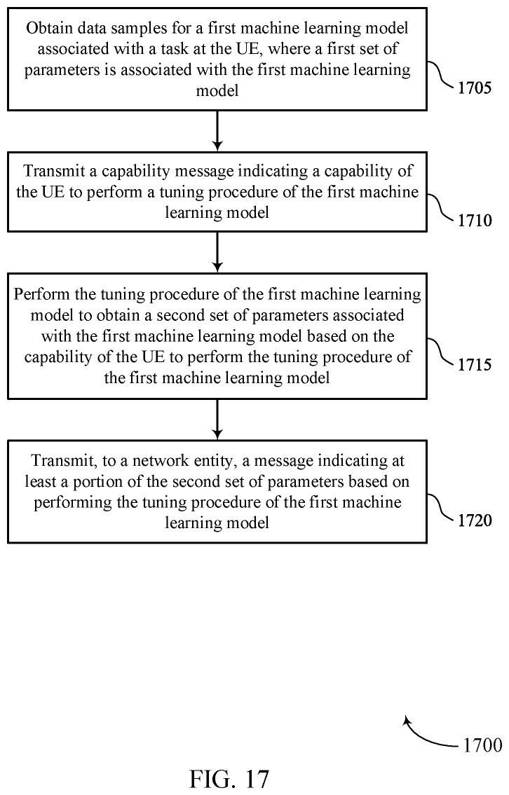

FIG. 17 illustrates a flowchart illustrating a method 1700 that supports model tuning for cross node machine learning in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include obtaining data samples for a first machine learning model associated with a task at the UE, where a first set of parameters is associated with the first machine learning model. The operations of 1705 may be performed in accordance with examples as disclosed herein. In some examples, aspects of the operations of 1705 may be performed by a data samples component 1125 as described with reference to FIG. 11.

At 1710, the method may include transmitting a capability message indicating a capability of the UE to perform a tuning procedure of the first machine learning model. The operations of 1710 may be performed in accordance with examples as disclosed herein. In some examples, aspects of the operations of 1710 may be performed by a capability message component 1130 as described with reference to FIG. 11.

At 1715, the method may include performing the tuning procedure of the first machine learning model to obtain a second set of parameters associated with the first machine learning model based on the capability of the UE to perform the tuning procedure of the first machine learning model. The operations of 1715 may be performed in accordance with examples as disclosed herein. In some examples, aspects of the operations of 1715 may be performed by a tuning procedure component 1135 as described with reference to FIG. 11.

At 1720, the method may include transmitting, to a network entity, a message indicating at least a portion of the second set of parameters based on performing the tuning procedure of the first machine learning model. The operations of 1720 may be performed in accordance with examples as disclosed herein. In some examples, aspects of the operations of 1720 may be performed by a message transmission component 1140 as described with reference to FIG. 11.

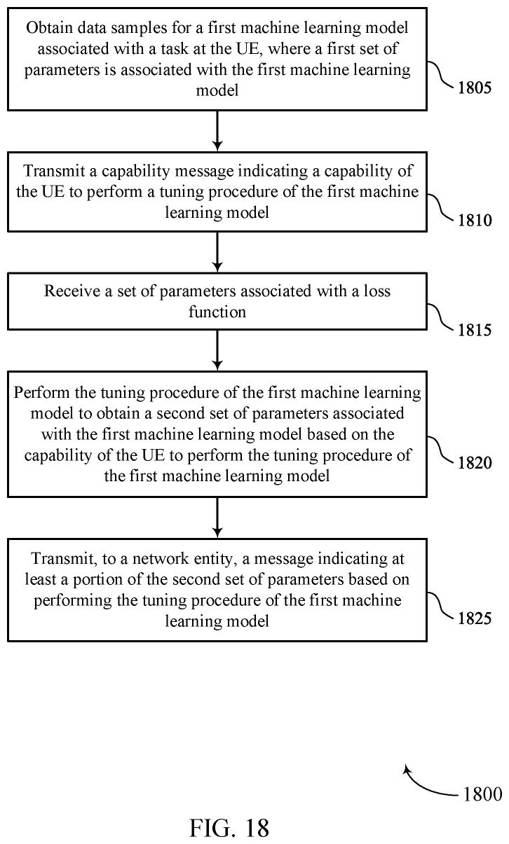

FIG. 18 illustrates a flowchart illustrating a method 1800 that supports model tuning for cross node machine learning in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include obtaining data samples for a first machine learning model associated with a task at the UE, where a first set of parameters is associated with the first machine learning model. The operations of 1805 may be performed in accordance with examples as disclosed herein. In some examples, aspects of the operations of 1805 may be performed by a data samples component 1125 as described with reference to FIG. 11.

At 1810, the method may include transmitting a capability message indicating a capability of the UE to perform a tuning procedure of the first machine learning model. The operations of 1810 may be performed in accordance with examples as disclosed herein. In some examples, aspects of the operations of 1810 may be performed by a capability message component 1130 as described with reference to FIG. 11.

At 1815, the method may include receiving a set of parameters associated with a loss function. The operations of 1815 may be performed in accordance with examples as disclosed herein. In some examples, aspects of the operations of 1815 may be performed by a loss function parameters component 1180 as described with reference to FIG. 11.

At 1820, the method may include performing the tuning procedure of the first machine learning model to obtain a second set of parameters associated with the first machine learning model based on the capability of the UE to perform the tuning procedure of the first machine learning model. The operations of 1820 may be performed in accordance with examples as disclosed herein. In some examples, aspects of the operations of 1820 may be performed by a tuning procedure component 1135 as described with reference to FIG. 11.

At 1825, the method may include transmitting, to a network entity, a message indicating at least a portion of the second set of parameters based on performing the tuning procedure of the first machine learning model. The operations of 1825 may be performed in accordance with examples as disclosed herein. In some examples, aspects of the operations of 1825 may be performed by a message transmission component 1140 as described with reference to FIG. 11.

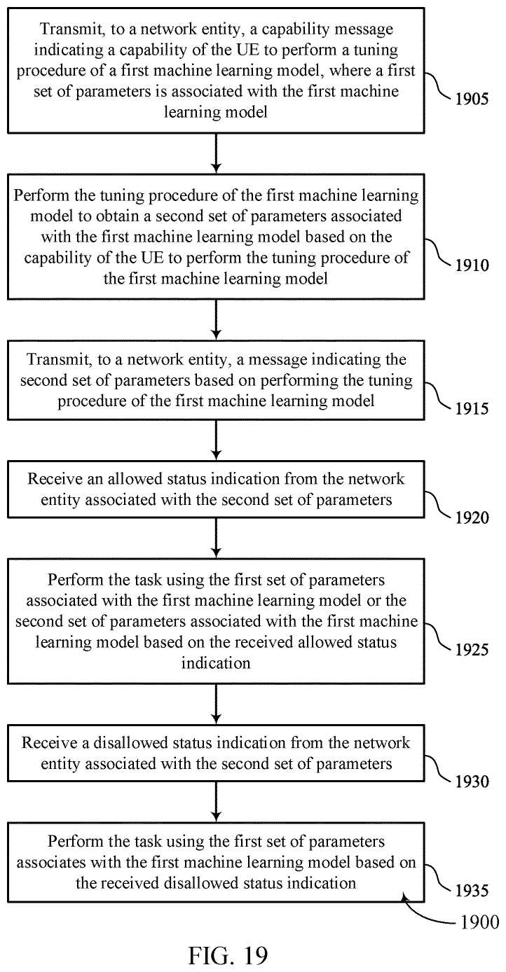

FIG. 19 illustrates a flowchart illustrating a method 1900 that supports model tuning for cross node machine learning in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include transmitting, to a network entity, a capability message indicating a capability of the UE to perform a tuning procedure of a first machine learning model, where a first set of parameters is associated with the first machine learning model. The operations of 1905 may be performed in accordance with examples as disclosed herein. In some examples, aspects of the operations of 1905 may be performed by a capability message component 1130 as described with reference to FIG. 11.

At 1910, the method may include performing the tuning procedure of the first machine learning model to obtain a second set of parameters associated with the first machine learning model based on the capability of the UE to perform the tuning procedure of the first machine learning model. The operations of 1910 may be performed in accordance with examples as disclosed herein. In some examples, aspects of the operations of 1910 may be performed by a tuning procedure component 1135 as described with reference to FIG. 11.

At 1915, the method may include transmitting, to a network entity, a message indicating the second set of parameters based on performing the tuning procedure of the first machine learning model. The operations of 1915 may be performed in accordance with examples as disclosed herein. In some examples, aspects of the operations of 1915 may be performed by a message transmission component 1140 as described with reference to FIG. 11.

At 1920, the method may include receiving an allowed status indication from the network entity associated with the second set of parameters. The operations of 1920 may be performed in accordance with examples as disclosed herein. In some examples, aspects of the operations of 1920 may be performed by a first indication reception component 1145 as described with reference to FIG. 11.

At 1925, the method may include performing the task using the first set of parameters associated with the first machine learning model or the second set of parameters associated with the first machine learning model based on the received allowed status indication. The operations of 1925 may be performed in accordance with examples as disclosed herein. In some examples, aspects of the operations of 1925 may be performed by a task performance component 1150 as described with reference to FIG. 11.

At 1930, the method may include receiving a disallowed status indication from the network entity associated with the second set of parameters. The operations of 1930 may be performed in accordance with examples as disclosed herein. In some examples, aspects of the operations of 1930 may be performed by a disallowed status reception component 1155 as described with reference to FIG. 11.

At 1935, the method may include performing the task using the first set of parameters associates with the first machine learning model based on the received disallowed status indication. The operations of 1935 may be performed in accordance with examples as disclosed herein. In some examples, aspects of the operations of 1935 may be performed by a task performance component 1150 as described with reference to FIG. 11.

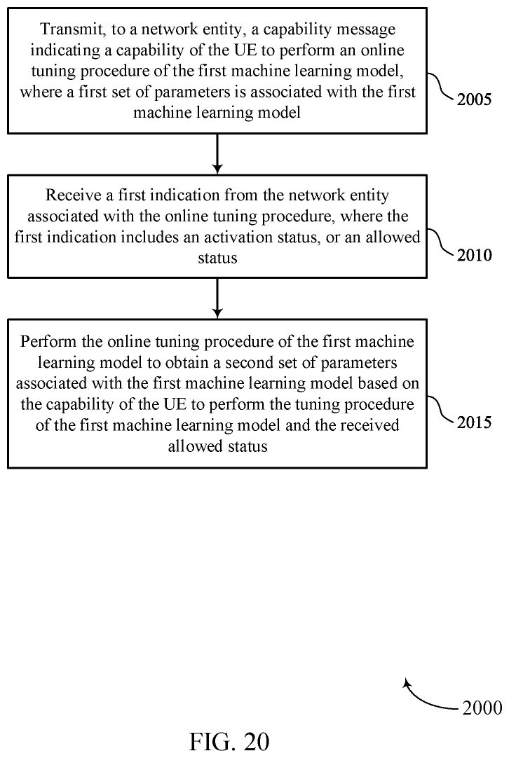

FIG. 20 illustrates a flowchart illustrating a method 2000 that supports model tuning for cross node machine learning in accordance with one or more aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include transmitting, to a network entity, a capability message indicating a capability of the UE to perform an online tuning procedure of the first machine learning model, where a first set of parameters is associated with the first machine learning model. The operations of 2005 may be performed in accordance with examples as disclosed herein. In some examples, aspects of the operations of 2005 may be performed by a capability message component 1130 as described with reference to FIG. 11.

At 2010, the method may include receiving a first indication from the network entity associated with the online tuning procedure, where the first indication includes an activation status, or an allowed status. The operations of 2010 may be performed in accordance with examples as disclosed herein. In some examples, aspects of the operations of 2010 may be performed by a first indication reception component 1145 as described with reference to FIG. 11.

At 2015, the method may include performing the online tuning procedure of the first machine learning model to obtain a second set of parameters associated with the first machine learning model based on the capability of the UE to perform the tuning procedure of the first machine learning model and the received allowed status. The operations of 2015 may be performed in accordance with examples as disclosed herein. In some examples, aspects of the operations of 2015 may be performed by an online tuning procedure component 1160 as described with reference to FIG. 11.

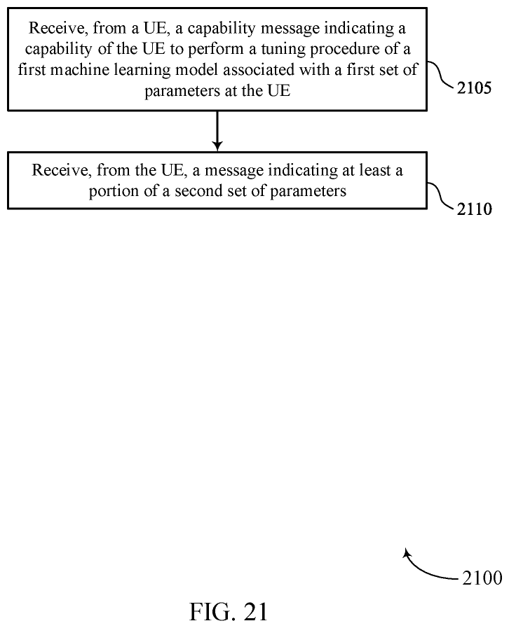

FIG. 21 illustrates a flowchart illustrating a method 2100 that supports model tuning for cross node machine learning in accordance with one or more aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2105, the method may include receiving, from a UE, a capability message indicating a capability of the UE to perform a tuning procedure of a first machine learning model associated with a first set of parameters at the UE. The operations of 2105 may be performed in accordance with examples as disclosed herein. In some examples, aspects of the operations of 2105 may be performed by a capability reception component 1525 as described with reference to FIG. 15.

At 2110, the method may include receiving, from the UE, a message indicating at least a portion of a second set of parameters. The operations of 2110 may be performed in accordance with examples as disclosed herein. In some examples, aspects of the operations of 2110 may be performed by a message reception component 1530 as described with reference to FIG. 15.

The following provides an overview of aspects of the present disclosure:

Aspect 1: A method for wireless communication at a UE, comprising: obtaining data samples for a first machine learning model associated with a task at the UE, wherein a first set of parameters is associated with the first machine learning model: transmitting a capability message indicating a capability of the UE to perform a tuning procedure of the first machine learning model: performing the tuning procedure of the first machine learning model to obtain a second set of parameters associated with the first machine learning model based at least in part on the capability of the UE to perform the tuning procedure of the first machine learning model; and transmitting, to a network entity, a message indicating at least a portion of the second set of parameters based at least in part on performing the tuning procedure of the first machine learning model.

Aspect 2: The method of aspect 1, wherein the first machine learning model comprises an encoder portion of a second machine learning model, and a third machine learning model comprises a decoder portion of the second machine learning model.

Aspect 3: The method of aspect 2, wherein performing the tuning procedure of the first machine learning model further comprises: receiving a set of parameters associated with a loss function.

Aspect 4: The method of aspect 3, further comprising: transmitting a message associated with a forward propagation procedure.

Aspect 5: The method of any of aspects 3 through 4, further comprising: receiving a message associated with a backward propagation procedure for adjusting parameters associated with an encoder, wherein the message indicates a gradient associated with the loss function; and updating the parameters associated with the encoder based at least in part on the message.

Aspect 6: The method of any of aspects 3 through 5, further comprising: receiving the set of parameters associated with the loss function; and updating parameters associated with the decoder portion of the second machine learning model based at least in part on the set of parameters.

Aspect 7: The method of any of aspects 1 through 6, wherein transmitting the capability message comprises: transmitting an indication of a set of machine learning models supported by the UE.

Aspect 8: The method of any of aspects 1 through 7, wherein the task comprises a CSI feedback task.

Aspect 9: The method of any of aspects 1 through 8, wherein performing the tuning procedure of the first machine learning model further comprises: updating parameters associated with an encoder, parameters associated with a decoder, or both using the second set of parameters.

Aspect 10: The method of aspect 9, wherein performing the tuning procedure of the first machine learning model comprises: performing an online tuning procedure.

Aspect 11: The method of aspect 10, wherein performing the online tuning procedure of the first machine learning model comprises: updating the second set of parameters associated with the encoder using the second set of parameters for the first machine learning model in performing the task.

Aspect 12: The method of any of aspects 9 through 11, wherein performing the tuning procedure of the first machine learning model comprises: performing an offline tuning procedure.

Aspect 13: The method of aspect 12, wherein performing the offline tuning procedure of the first machine learning model comprises: updating the second set of parameters associated with the encoder using the first set of parameters for the first machine learning model in performing the task.

Aspect 14: The method of any of aspects 12 through 13, further comprising: transmitting a third indication to the network entity, wherein the third indication indicates an availability of a second encoder, wherein the second encoder is associated with performing the offline tuning procedure.

Aspect 15: The method of any of aspects 1 through 14, wherein performing the tuning procedure further comprises: receiving a first indication from the network entity associated with performing the tuning procedure of the first machine learning model, wherein the first indication comprises an activation status or an allowed status; and transmitting a second indication to the network entity in response to the first indication, wherein the second indication comprises an activation indication associated with starting to perform the tuning procedure or a deactivation indication associated with stopping the tuning procedure.

Aspect 16: The method of aspect 15, further comprising: transmitting an activation request to the network entity, wherein receiving the first indication is based at least in part on the activation request.

Aspect 17: The method of any of aspects 15 through 16, further comprising: receiving a fourth indication from the network entity, wherein the fourth indication comprises a deactivation indication associated with stopping the tuning procedure.

Aspect 18: The method of any of aspects 1 through 17, wherein performing the tuning procedure of the first machine learning model further comprises: updating parameters associated with an encoder, parameters associated with a decoder, or both using the second set of parameters based at least in part on a gradient associated with the first set of parameters and the second set of parameters.

Aspect 19: The method of aspect 18, wherein updating parameters associated with an encoder, parameters associated with a decoder, or both further comprises: receiving a set of parameters associated with a loss function; and transmitting a message associated with a forward propagation procedure.

Aspect 20: The method of aspect 19, further comprising: receiving a message associated with a backward propagation procedure for adjusting parameters associated with an encoder, parameters associated with a decoder, or both, wherein the message indicates a gradient associated with the loss function; and updating the parameters associated with the encoder, parameters associated with a decoder, or both based at least in part on the message.

Aspect 21: The method of any of aspects 1 through 20, wherein the UE receives the indication of the first set of parameters via broadcast signaling, dedicated signaling, or both.

Aspect 22: A method for wireless communication at a UE with a first set of parameters associated with a first machine learning model for a task, comprising: transmitting, to a network entity, a capability message indicating a capability of the UE to perform a tuning procedure of a first machine learning model, wherein a first set of parameters is associated with the first machine learning model: performing the tuning procedure of the first machine learning model to obtain a second set of parameters associated with the first machine learning model based at least in part on the capability of the UE to perform the tuning procedure of the first machine learning model; transmitting, to a network entity, a message indicating the second set of parameters based at least in part on performing the tuning procedure of the first machine learning model: receiving an allowed status indication from the network entity associated with the second set of parameters: performing the task using the first set of parameters associated with the first machine learning model or the second set of parameters associated with the first machine learning model based on the received allowed status indication; receiving a disallowed status indication from the network entity associated with the second set of parameters; and performing the task using the first set of parameters associates with the first machine learning model based on the received disallowed status indication.

Aspect 23: The method of aspect 22, further comprising: autonomously determining whether to perform the task using the first set of parameters associated with the first machine learning model or using the second set of parameters associated with the first machine learning model based at least in part on the received allowed status indication.

Aspect 24: A method for wireless communication at a UE with a first set of parameters associated with a first machine learning model for a task, comprising: transmitting, to a network entity, a capability message indicating a capability of the UE to perform an online tuning procedure of the first machine learning model, wherein a first set of parameters is associated with the first machine learning model: receiving a first indication from the network entity associated with the online tuning procedure, wherein the first indication comprises an activation status, or an allowed status; and performing the online tuning procedure of the first machine learning model to obtain a second set of parameters associated with the first machine learning model based at least in part on the capability of the UE to perform the tuning procedure of the first machine learning model and the received allowed status.

Aspect 25: A method for wireless communication at a network entity, comprising: receiving, from a UE, a capability message indicating a capability of the UE to perform a tuning procedure of a first machine learning model associated with a first set of parameters at the UE; and receiving, from the UE, a message indicating at least a portion of a second set of parameters.

Aspect 26: The method of aspect 25, wherein the first machine learning model comprises an encoder portion of a second machine learning model, and a third machine learning model comprises a decoder portion of the second machine learning model.

Aspect 27: The method of any of aspects 25 through 26, wherein receiving the capability message comprises: receiving an indication of a set of machine learning models supported by the UE.

Aspect 28: The method of any of aspects 25 through 27, wherein receiving the message is associated with receiving channel state information feedback.

Aspect 29: The method of any of aspects 25 through 28, further comprising: transmitting, to the UE, a first indication associated with performing a tuning procedure of the first machine learning model, wherein the first indication comprises an activation status or an allowed status; and receiving, from the UE, a second indication in response to the first indication, wherein the second indication comprises an activation indication associated with starting to perform the tuning procedure or a deactivation indication associated with stopping the tuning procedure.

Aspect 30: The method of aspect 29, further comprising: receiving, from the UE, an activation request, wherein transmitting the first indication is based at least in part on the activation request.

Aspect 31: The method of any of aspects 29 through 30, further comprising: transmitting, to the UE, a third indication, wherein the third indication comprises a deactivation indication associated with stopping the tuning procedure.

Aspect 32: An apparatus for wireless communication at a UE, comprising a processor: memory coupled with the processor; and instructions stored in the memory and executable by the processor to cause the apparatus to perform a method of any of aspects 1 through 21.

Aspect 33: An apparatus for wireless communication at a UE, comprising at least one means for performing a method of any of aspects 1 through 21.

Aspect 34: A non-transitory computer-readable medium storing code for wireless communication at a UE, the code comprising instructions executable by a processor to perform a method of any of aspects 1 through 21.

Aspect 35: An apparatus for wireless communication at a UE with a first set of parameters associated with a first machine learning model for a task, comprising a processor: memory coupled with the processor; and instructions stored in the memory and executable by the processor to cause the apparatus to perform a method of any of aspects 22 through 22.

Aspect 36: An apparatus for wireless communication at a UE with a first set of parameters associated with a first machine learning model for a task, comprising at least one means for performing a method of any of aspects 22 through 22.

Aspect 37: A non-transitory computer-readable medium storing code for wireless communication at a UE with a first set of parameters associated with a first machine learning model for a task, the code comprising instructions executable by a processor to perform a method of any of aspects 22 through 22.

Aspect 38: An apparatus for wireless communication at a UE with a first set of parameters associated with a first machine learning model for a task, comprising a processor: memory coupled with the processor; and instructions stored in the memory and executable by the processor to cause the apparatus to perform a method of any of aspects 24 through 24.

Aspect 39: An apparatus for wireless communication at a UE with a first set of parameters associated with a first machine learning model for a task, comprising at least one means for performing a method of any of aspects 24 through 24.

Aspect 40: A non-transitory computer-readable medium storing code for wireless communication at a UE with a first set of parameters associated with a first machine learning model for a task, the code comprising instructions executable by a processor to perform a method of any of aspects 24 through 24.

Aspect 41: An apparatus for wireless communication at a network entity, comprising a processor: memory coupled with the processor; and instructions stored in the memory and executable by the processor to cause the apparatus to perform a method of any of aspects 25 through 31.

Aspect 42: An apparatus for wireless communication at a network entity, comprising at least one means for performing a method of any of aspects 25 through 31.

Aspect 43: A non-transitory computer-readable medium storing code for wireless communication at a network entity, the code comprising instructions executable by a processor to perform a method of any of aspects 25 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, NR, or 5G-Advanced networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
obtaining data samples for a first machine learning model associated with a task at the UE, wherein a first set of parameters is associated with the first machine learning model;
transmitting a capability message indicating a capability of the UE to perform a tuning procedure of the first machine learning model;
performing the tuning procedure of the first machine learning model to obtain a second set of parameters associated with the first machine learning model based at least in part on the capability of the UE to perform the tuning procedure of the first machine learning model; and
transmitting, to a network entity, a message indicating at least a portion of the second set of parameters based at least in part on performing the tuning procedure of the first machine learning model.

2. The method of claim 1, wherein the first machine learning model comprises an encoder portion of a second machine learning model, and a third machine learning model comprises a decoder portion of the second machine learning model.

3. The method of claim 2, wherein performing the tuning procedure of the first machine learning model further comprises:
receiving a set of parameters associated with a loss function.

4. The method of claim 3, further comprising:
transmitting a message associated with a forward propagation procedure.

5. The method of claim 3, further comprising:
receiving a message associated with a backward propagation procedure for adjusting parameters associated with an encoder, wherein the message indicates a gradient associated with the loss function; and
updating the parameters associated with the encoder based at least in part on the message.

6. The method of claim 3, further comprising:
receiving the set of parameters associated with the loss function; and
updating parameters associated with the decoder portion of the second machine learning model based at least in part on the set of parameters.

7. The method of claim 1, wherein transmitting the capability message comprises:
transmitting an indication of a set of machine learning models supported by the UE.

8. The method of claim 1, wherein the task comprises a Channel State Information (CSI) feedback task.

9. The method of claim 1, wherein performing the tuning procedure of the first machine learning model further comprises:
updating parameters associated with an encoder, parameters associated with a decoder, or both using the second set of parameters.

10. The method of claim 9, wherein performing the tuning procedure of the first machine learning model comprises:
performing a tuning procedure.

11. (canceled)

12. The method of claim 9, wherein performing the tuning procedure of the first machine learning model comprises:
performing an offline tuning procedure.

13. The method of claim 12, wherein performing the offline tuning procedure of the first machine learning model comprises:
updating the second set of parameters associated with the encoder using the first set of parameters for the first machine learning model in performing the task.

14. (canceled)

15. The method of claim 1, wherein performing the tuning procedure further comprises:
receiving a first indication from the network entity associated with performing the tuning procedure of the first machine learning model, wherein the first indication comprises an activation status or an allowed status; and
transmitting a second indication to the network entity in response to the first indication, wherein the second indication comprises an activation indication associated with starting to perform the tuning procedure or a deactivation indication associated with stopping the tuning procedure.

16. The method of claim 15, further comprising:
transmitting an activation request to the network entity, wherein receiving the first indication is based at least in part on the activation request.

17. The method of claim 15, further comprising:
receiving a fourth indication from the network entity, wherein the fourth indication comprises a deactivation indication associated with stopping the tuning procedure.

18. The method of claim 1, wherein performing the tuning procedure of the first machine learning model further comprises:
updating parameters associated with an encoder, parameters associated with a decoder, or both using the second set of parameters based at least in part on a gradient associated with the first set of parameters and the second set of parameters.

19. The method of claim 18, wherein updating parameters associated with an encoder, parameters associated with a decoder, or both further comprises:
receiving a set of parameters associated with a loss function; and
transmitting a message associated with a forward propagation procedure.

20. (canceled)

21. The method of claim 1, wherein the UE receives the indication of the first set of parameters via broadcast signaling, dedicated signaling, or both.

22. A method for wireless communication at a user equipment (UE) with a first set of parameters associated with a first machine learning model for a task, comprising:
transmitting, to a network entity, a capability message indicating a capability of the UE to perform a tuning procedure of a first machine learning model, wherein a first set of parameters is associated with the first machine learning model;
performing the tuning procedure of the first machine learning model to obtain a second set of parameters associated with the first machine learning model based at least in part on the capability of the UE to perform the tuning procedure of the first machine learning model;
transmitting, to a network entity, a message indicating the second set of parameters based at least in part on performing the tuning procedure of the first machine learning model;
receiving an allowed status indication from the network entity associated with the second set of parameters;
performing the task using the first set of parameters associated with the first machine learning model or the second set of parameters associated with the first machine learning model based at least in part on the received allowed status indication;
receiving a disallowed status indication from the network entity associated with the second set of parameters; and
performing the task using the first set of parameters associated with the first machine learning model based on the received disallowed status indication.

23. The method of claim 22, further comprising:
autonomously determining whether to perform the task using the first set of parameters associated with the first machine learning model or using the second set of parameters associated with the first machine learning model based at least in part on the received allowed status indication.

24. A method for wireless communication at a user equipment (UE) with a first set of parameters associated with a first machine learning model for a task, comprising:
transmitting, to a network entity, a capability message indicating a capability of the UE to perform a tuning procedure of the first machine learning model, wherein a first set of parameters is associated with the first machine learning model;
receiving a first indication from the network entity associated with the tuning procedure, wherein the first indication comprises an activation status, or an allowed status; and
performing the tuning procedure of the first machine learning model to obtain a second set of parameters associated with the first machine learning model based at least in part on the capability of the UE to perform the tuning procedure of the first machine learning model and the received allowed status.

25-30. (canceled)
